(19) United States
(12) Patent Application Publication
(10) Pub. No.: US 2008/0016314 A1
(43) Pub. Date: Jan. 17, 2008

(54) Diversity-based security system and method

(76) Inventors: Lixin Li, Fairfax, VA (US); James Edward Just, Vienna, VA (US)

Correspondence Address: MCGUIREWOODS, LLP, 1750 TYSONS BLVD, SUITE 1800, MCLEAN, VA, 22102, US

(21) Appl. No.: 11/826,184

(22) Filed: Jul. 12, 2007

Related U.S. Application Data
(60) Provisional application No. 60/830,122, filed on Jul. 12, 2006.

(51) Int. Cl. G06F 12/14

(52) U.S. Cl. 711/200; 711/E12.091

(57) ABSTRACT

The prevalence of identical vulnerabilities across software monocultures has emerged as the biggest challenge for protecting the Internet from large-scale attacks against system applications. Artificially introduced software diversity provides a suitable defense against this threat, since it can potentially eliminate common-mode vulnerabilities across these systems. Systems and methods are provided that overcomes these challenges to support address-space randomization of the Windows® operating system. These techniques provide effectiveness against a wide range of attacks.

### CROSS-REFERENCE TO RELATED APPLICATIONS

This application claims priority to U.S. Provisional Application No. 60/830,122 entitled, “A DIVERSITY-BASED SECURITY SYSTEM AND METHOD,” filed Jul. 12, 2006, the disclosure of which is incorporated by reference herein in its entirety.

### BACKGROUND OF THE INVENTION

1.0 Field of the Invention

The invention relates generally to systems and methods to protect networks and applications from attacks and, more specifically, to protect networks and applications such as Internet related applications from various types of attacks such as memory corruption attacks, data attacks, and the like.

2.0 Related Art

Software monocultures represent one of the greatest Internet threats, since they enable construction of attacks that can succeed against a large fraction of the hosts on the Internet. Automated introduction of software diversity has been suggested as a method to address this challenge. In addition to providing a defense against attacks due to “worms” and “botnets,” automated diversity generation is a necessary building block for construction of practical intrusion-tolerant systems, i.e., systems that use multiple instances of commercial-off-the-shelf (COTS) software/hardware to ward off attacks, and continue to provide their critical services. Such systems cannot be built without diversity, since all constituent copies will otherwise share common vulnerabilities, and hence can all be brought down using a single attack; and they can't be built economically without artificial diversity techniques, since manual development of diversity can be prohibitively expensive.

An approach for automated introduction of diversity is that of a random (yet systematic) software transformation. Such a transformation needs to preserve the functional behavior of the software as expected by its programmer, but break the behavioral assumptions made by attackers. If formal behavior specifications of the software were available, one could use it as a basis to identify transformations that ensure conformance with these specifications. However, in practice, such specifications aren't available. An alternative is to focus on transformations that preserve the semantics of the underlying programming language. Unfortunately, the semantics of the C-programming language, which has been used to develop the vast majority of security-sensitive software in use today, imposes tight constraints on implementation, leaving only a few sources for diversity introduction:
Randomization of memory locations where program objects (code or data) are stored. Such randomization can defeat pointer corruption attacks, since the attacker no longer knows the “correct” value to be used in corruption. It may also defeat overflow attacks, since an attacker is no longer able to predict the object that will be overwritten.
Randomization of the representation used for code. This randomization defeats injected code attacks, since the attacker no longer knows the representation used for valid code.
   Fortunately, these randomization techniques seem adequate to handle the most popular attacks today, which rely on memory corruption and/or code injection. Over 75% of the US-CERT advisories in recent years, and almost every known worm on the Internet, have been based on such attacks.

The availability of hardware/software support for enforcing non-executability of data (e.g., the NX feature of Win XP SP2, which is also known as “no execute,” prevents code execution from data pages such as the default heap, various stacks, and memory pools) which defeats all injected code attacks, has obviated the need for instruction set randomization to some extent. Address space randomization, on the other hand, protects against several other classes of attacks that are not addressed by NX, e.g., existing code attacks (also called return-to-libc attacks), and attacks on security critical data. The importance of data attacks is known and has been shown that it is relatively easy to exploit memory corruption attacks to alter security sensitive data to achieve administrator or user-level access on target system.

However, the true potential of automated diversity in protecting against Internet-wide threats won't be realized unless randomization solutions can be developed for the Windows® trademark of Microsoft Corporation) operating system (and similar operating systems), which accounts for over 90% of the computers on the Internet. It is apparent that advancement in security threat defense and prevention of successful attacks for users of Windows® is important. A solution that cannot be easily defeated, while being easily deployed should be a most welcomed technological advancement.

Automated diversity converts a memory error attack that might compromise host integrity into one that compromises availability by fail crashing the application. This is not acceptable for mission-critical systems where service availability is required. An ideal solution to this problem would learn from previous attacks to refine the defenses over time so that attacks have no significant effect on either the integrity or the availability of commercial-off-the-shelf (COTS) applications; again the solution works on binary and does not require source code or symbol access.

A better approach is needed that improves the ability of applications and networks to survive attacks.

### SUMMARY OF THE INVENTION

The invention provides systems and methods to alleviate deficiencies of the prior art, and substantially improve defenses against attacks. In one aspect of the invention, a computer-implemented method of providing address-space randomization for a Windows® operating system in a computer system is provided. The method includes the steps of rebasing system dynamic link libraries (DLLs), rebasing a Process Environment Block (PEB) and a Thread Environment Block (TEB), and randomizing a user mode process by hooking functions that set-up internal memory structures used by the user mode process, wherein internal memory structures, the rebased system DLLs, rebased PEB and rebased TEB are each located at different addresses after the respective rebasing step providing a defense against a memory corruption attack and enhancing security of the user mode process in the computer system by generating an alert or defensive action upon an invalid access to a pre-rebased address.

In another aspect, a computer-implemented method of providing address-space randomization for a Windows® operating system in a computer system is provided. The method includes the steps of rebasing a system dynamic link library (DLL) from an initial DLL address to another address, at kernel mode, rebasing a Process Environment Block (PEB) and Thread Environment Block (TEB) from an initial PEB and initial TEB address to different PEB address and different TEB address, at kernel mode, rebasing a primary heap from an initial primary heap address to a different primary heap address, from kernel mode, wherein access to any one of: the initial DLL address, the initial PEB address, the initial TEB address, and initial primary heap address causes an alert or defensive action in the computer system.

In another aspect, a computer-implemented method to perform runtime stack inspection for stack buffer overflow early detection during a computer system attack is provided. The method includes the steps of hooking a memory sensitive function at DLL load time based on an application setting, the memory sensitive function including a function related to any one of: a memcpy function family, a strcpy function family, and a printf function family, detecting a violation of a memory space during execution of the hooked memory sensitive function, and reacting to the violation by generating an alert or preventing further action by a process associated with the hooked function in the computer system.

In yet another aspect, a computer-implemented method to perform Exception Handler (EH) based access validation and for detecting a computer attack is provided. The method includes the steps of providing a Exception Handler to a EH list in a computer system employing a Windows® operating system and keeping the provided Exception Handler (EH) as the first EH in the list, making a copy of a protected resource, changing a pointer to the protected resource to a erroneous or normally invalid value so that access of the protected resource generates an access violation, upon the access violation, validating if an accessing instruction is from a legitimate resource having an appropriate permission, if the step of validating fails to identify a legitimate resource as a source of the access violation, raising an attack alert.

In another aspect, a computer implemented method to inject a user mode DLL into a newly created process at initialization time of the process in a computer system employing a Windows® operating system to prevent computer attacks, the method comprising steps of: finding or creating a kernel memory address that is shared in user mode by mapping the kernel memory address to a virtual address in a user mode address space of a process, copying instructions in binary form that calls user mode Load Library to the found or created kernel mode address from kernel driver creating shared Load Library instructions, and queuing an user mode Asynchronous Procedure Call (APC) call to execute the shared Load Library instructions from user address space of a desired process when it is mapping kernel32 DLL.

In still another aspect, a system for providing address-space randomization for a Windows® operating system in a computer system is provided. The system comprises means for rebasing a system dynamic link library (DLL) from an initial DLL address to another address, at kernel mode, means for rebasing a Process Environment Block (PEB) and Thread Environment Block (TEB) from an initial PEB and initial TEB address to different PEB address and different TEB address, at kernel mode, and means for rebasing a primary heap from an initial primary heap address to a different primary heap address, from kernel mode, wherein access to any one of: the initial DLL address, the initial PEB address, the initial TEB address, and initial primary heap address causes an alert or defensive action in the computer system.

In another aspect, a computer-implemented method of providing address-space randomization for an operating system in a computer system is provided comprising at least any of the steps a) through e): a) rebasing one or more application dynamic link libraries (DLLs), b) rebasing thread stack and randomizing its starting frame offset, c) rebasing one or more heap, d) rebasing a process parameter environment variable block, and e) rebasing primary stack with customized loader wherein at least any one of: the rebased application DLLs, rebased thread stack and its starting frame offset, rebased heap base, the rebased process parameter environment variable block, the rebased primary stack are each located at different memory address away from a respective first address prior to rebasing, and after said respective rebasing step, an access to any first respective address causes an alert or defensive action in the computer system.

In still another aspect, a computer program product having computer code embedded in a computer readable medium, the computer code configured to execute the following at least any one of the steps a) through e): a) rebasing one or more application dynamic link libraries (DLLs), b) rebasing thread stack and randomizing its starting frame offset, c) rebasing one or more heap, d) rebasing a process parameter environment variable block, and e) rebasing primary stack with customized loader, wherein at least any one of: the rebased application DLLs, rebased thread stack and its starting frame offset, rebased heap base, the rebased process parameter environment variable block, the rebased primary stack are each located at different memory address away from a respective first address prior to rebasing, and after said respective rebasing step, an access to any first respective address causes an alert or defensive action in the computer system.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and, together with the detailed description, serve to explain the principles of the invention. No attempt is made to show structural details of the invention in more detail than may be necessary for a fundamental understanding of the invention and the various ways in which it may be practiced. In the drawings:

FIG. 1A is a block diagram of an exemplary high-level system architecture of the invention, according to principles of the invention;

FIG. 1B is an exemplary functional block diagram of the system architecture of DAWSON, according to principles of the invention;

FIG. 2A is a functional flow diagram showing exemplary kernel mode activity of DAWSON kernel component, according to principles of the invention;

FIG. 2B is a flow diagram showing steps of a one-time set-up activity at the entry code of DAWSON user module, implemented as a DLL, according to principles of the invention;

FIG. 2C is a flow diagram showing steps for iterative activities that happen in the DAWSON user module, during runtime throughout a user process lifetime, according to principles of the invention;

FIG. 3 is a flow diagram showing more exemplary detailed steps of step K0 of FIG. 2A, according to principles of the invention;

FIG. 3A is a flow diagram showing additional exemplary steps of step K1 of FIG. 2A, according to principles of the invention;

FIG. 3B is a flow diagram showing additional exemplary steps of step K2 of FIG. 2A, according to principles of the invention;

FIG. 3C is an exemplary flow diagram showing additional exemplary steps of step K3 of FIG. 2A;

FIG. 3D is an exemplary flow diagram showing more detailed exemplary steps of step K4 of FIG. 2A;

FIG. 3E is an exemplary flow diagram showing additional exemplary steps of step K5 of FIG. 2A;

FIG. 3F is a flow diagram showing more detailed exemplary steps of step K6 of FIG. 2A;

FIG. 3G is a flow diagram showing more detailed exemplary steps of step K7 of FIG. 2A;

FIG. 3H is a flow diagram showing more detailed exemplary steps of step K8 of FIG. 2A, according to principles of the invention;

FIG. 3I is a flow diagram showing more detailed exemplary steps of step K1 of FIG. 2A, according to principles of the invention;

FIGS. 4A-4D are exemplary flow diagrams showing additional exemplary steps of step U4 of FIG. 2B, according to principles of the invention;

FIG. 5 is a relational flow diagram showing additional exemplary steps of step UR-4 of FIG. 2C;

FIG. 6 is a relational flow diagram illustrating step UR-4 of FIG. 2C, in particular, a DLL rebase randomization, according to principles of the invention;

FIGS. 7 and 8 are exemplary relational flow diagrams further illustrating step UR-4 of FIG. 2C; in particular, a stack rebasing, according to principles of the invention;

FIG. 9 is an illustration further illustrating step UR-4 of FIG. 2C, in particular, heap base randomization and heap block protection, according to principles of the invention;

FIG. 10A is a flow diagram showing additional or more detailed exemplary steps of step U3 of FIG. 2B, according to principles of the invention;

FIG. 10B is a flow diagram showing additional exemplary steps of step U5 of FIG. 2B, according to principles of the invention;

FIG. 11 is a functional flow diagram illustrating the operation of the VEH verification module, according to principles of the invention;

FIG. 12 is a flow diagram showing additional exemplary steps of step U6 of FIG. 2B, according to principles of the invention;

FIG. 13 is a flow diagram showing additional exemplary steps of step UR2 of FIG. 2C, according to principles of the invention;

FIG. 14 is an illustration of a stack buffer overflow runtime detection scenario, according to principles of the invention;

FIG. 15 is a flow diagram showing additional exemplary steps of step UR3 of FIG. 2C, according to principles of the invention;

FIG. 16 is a flow diagram showing additional exemplary steps of a customized loader, according to principles of the invention;

FIG. 17 is a flow diagram showing additional exemplary steps for step UR5 of FIG. 2C, according to principles of the invention;

FIG. 18 is a flow diagram showing additional exemplary steps of step UR5-R, according to principles of the invention;

FIG. 19 is a flow diagram showing additional exemplary steps of step UR6 of FIG. 2C, according to principles of the invention;

FIG. 20 is a flow diagram showing additional exemplary steps of step UR7 of FIG. 2C, according to principles of the invention;

FIG. 21 is a flow diagram showing additional exemplary steps of step UR8 of FIG. 2C, according to principles of the invention;

FIG. 22 is a relational block diagram showing the space of exploits that are based on spatial errors; and

FIG. 23 is an illustrating example showing a typical recent input history record, which is collected and maintained by function interceptor, according to principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention.

It is understood that the invention is not limited to the particular methodology, protocols, devices, apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

In general, automated diversity provides probabilistic (rather than deterministic) protection against attacks. Automated diversity is very valuable for protecting systems for several reasons:
Only the most determined attackers might succeed in their effort, while others are likely to give up after several unsuccessful attempts.
Even against the most determined adversary, the probabilistic technique buys valuable time. For example, rather than having to deal with attacks that succeed in tens of milliseconds, attacks take several minutes or more, which gives ample time for responding to attacks. Such responses may include:
   filtering out the source(s) of attacks by reconfiguring firewalls
   synthesizing and deploying a signature to block out attack-bearing requests after witnessing the first few.
On an Internet-scale, rapidly spreading worms such as “hit-list” worms are considered to pose the greatest challenge, as they can propagate through the Internet within a fraction of a second, before today's worm defense technologies can respond. Diversity-based defenses can slow down the propagation substantially, since each infection step would typically take minutes rather than milliseconds, thus giving time needed for the defensive technologies to respond. In addition to time delays, the need for repetition of attacks makes attacks against diversity-based defenses very “noisy,” and hence easier to be spotted by worm-defense (or other defensive) technologies.
In an intrusion tolerant system comprising k copies of a vulnerable server, the likelihood of simultaneous compromise of all copies decreases exponentially with k. If the probability of successful attack on a single server instance is 10⁻⁴ for example, this probability reduces to the order of 10⁻¹² with 3 copies of the server.

For perspective, the architecture of a Windows® type operating system is quite different from UNIX, and poses several unique challenges that necessitate the development of new techniques for realizing randomization. Some of these challenges are:
Lack of UNIX-style shared libraries. In UNIX, dynamically loaded libraries contain position-independent code, which means that they can be shared across multiple processes even if they are loaded at different virtual memory addresses for each process. In contrast, Windows® DLLs are not position-independent. Hence, all programs that use a DLL need to load it at the same address in their virtual memory, or else, no sharing is possible. Since lack of sharing can seriously impair performance, we needed to develop techniques that can randomize locations of libraries without duplicating the code.
Difficulty of relocating critical DLLs. Security-critical DLLs such as ntdll and Kerne132 are mapped to a fixed memory location by Windows® very early in the boot process. These libraries are used by every Windows® application, and hence get mapped into this fixed location determined by Windows. Since most of the APIs targeted by attack code, including all of the system calls, reside in these DLLs, we needed to develop techniques to relocate these DLLs.
Storage of process-control data within user space. Unlike UNIX, which keeps all process control data within the kernel, Windows® stores process control data in user space in structures such as Process Environment Block (PEB) and Thread Environment Block (TEB). These structures are located at fixed memory addresses, and contain data that is of immense value to attackers, such as code pointers used by Windows, in addition to providing a place where code could be deposited and executed.
L ack of access to OS or application source code. This means that the primary approach used by ASR implementations on Linux, namely that of modifying the kernel code and/or transforming application source code, is not an option on Windows.

To preserve application availability, automated diversity can serve as main mechanism to detect attack, sometimes attacks may be detected earlier before it has a chance to overflow a memory pointer and sometimes the attack maybe detected later when an attack sneaks through the diversity protection and try to access certain system resources. When an attack is detected, usually in a form of exception from diversity protection, process memory, stack content and exception status are available for analysis in real time or offline, critical attack information like target address, attacker provided target value, and/or underlying vulnerability information like calling context when the attack happened, the vulnerable function location and size to overwrite the buffer maybe extracted and used to correlate back to recent inputs (suppose recent input history is preserved), a signature generator can generate a vulnerability-specific blocking filter to protect the attacked application from future exploits of that vulnerability. This blocking filter can be deployed to other hosts to protect them before they are attacked. And because the signature is vulnerability oriented and not attack specific, it is likely that such a signature for vulnerability in a common dll (like kernel32 or user32) in one program context can be reused in another program.

In certain aspects, the invention provides techniques to randomize the address space on Windows® systems (and similar systems) that address the above difficulties. The systems and methods of the invention, referred to generally herein as DAWSON (“Diversity Algorithms for Worrisome SOftware and Networks”). DAWSON applies diversity to user applications, as well as various Windows® services. DAWSON is robust and has been tested on XP installations with results showing that it protects all Windows® services, as well as applications such as the Internet Explorer and Microsoft Word.

Also included herein are classifications of memory corruption attacks, and a presentation of analytical results that estimate the success probabilities of these classes of attacks. The theoretical analysis is supported with experimental results for a range of sophisticated memory corruption attacks. The effectiveness of the DAWSON technique is demonstrated in defeating many real-world exploits.

Randomization is applied systematically to every local service and application running on Windows®. These randomization techniques are typically designed to work without requiring modifications to the Windows' kernel source (which is, of course, not easily obtained) or to applications. This transformation may be accomplished by implementing a combination of the following techniques:
Injecting a randomization DLL into a target process: Much of the randomization functionality is implemented in a DLL (dynamic link library). This randomizing DLL gets loaded very early in the process creation and “hooks” standard Windows® API functions relating to memory allocation, and randomizes the base address of memory regions returned. “Hooking” or “hooks” refers to interception of function calls, typically to DLL functions. Table 1 is an example showing the types of regions within virtual memory of a Windows® process and associated rebasing granularity.

TABLE 1

| | | | Granularity |
|---|---|---|---|
| Type | Description | Protection | of Rebasing |
| Free | Free space | Inaccessible | Not rebased |
| Code | Executable or DLL code | Read-only | 15 bits |
| Static data | Within executable or DLL | Read-Write | 15 bits |
| Stack | Process and thread stacks | Read-Write | 29 bits |
| Heap | Main and other heaps | Read-Write | 20 bits |
| TEB | Thread Environment Block | Read-Write | 19 bits |
| PEB | Process Environment Block | Read-Write | 19 bits |
| Parameters | Command-line and | Read-Write | 19 bits |
| | Environment variables | | |
| VAD | Returned by virtual memory | Read-Write | 15 bits |
| | allocation routines | | |
| VAD | Shared info for kernel and | Unwritable | Not rebased |
| | user mode | | |

Customized loader: Some of the memory allocation happens prior to the time when the randomization DLL gets loaded. To randomize memory allocated prior to this point, a customized loader is used, which makes use of lower level API functions provided by ntdll to achieve randomization.
Kernel driver: Base addresses of some memory regions are determined very early in the boot process, and to randomize these, a boot-time driver is implemented. In a couple of instances, in-memory patching of the kernel executable image is used, so that some hard-coded base addresses can be replaced by random values (such patching is kept to a bare minimum in order to minimize porting efforts across different versions of Windows.) The term “driver” in reference to Windows® corresponds roughly to the term “kernel module” in UNIX contexts. In particular, it is not necessary for such drivers to be associated with any devices.
   The transformation is aimed at randomizing the “absolute address” of every object in memory. This transformation will disrupt pointer corruption attacks. Such pointer corruption attacks overwrite pointer values with the address of some specific object chosen by the attacker, such as the code injected by the attacker into a buffer. With absolute address randomization, the attacker no longer knows the location of the objects of their interest, and hence such attacks would fail.

The memory map of a Windows® application consists of several different types of memory regions as shown in Table 1. Below, several aspects concerning an approach provided by the invention for randomizing each of these memory regions is described.

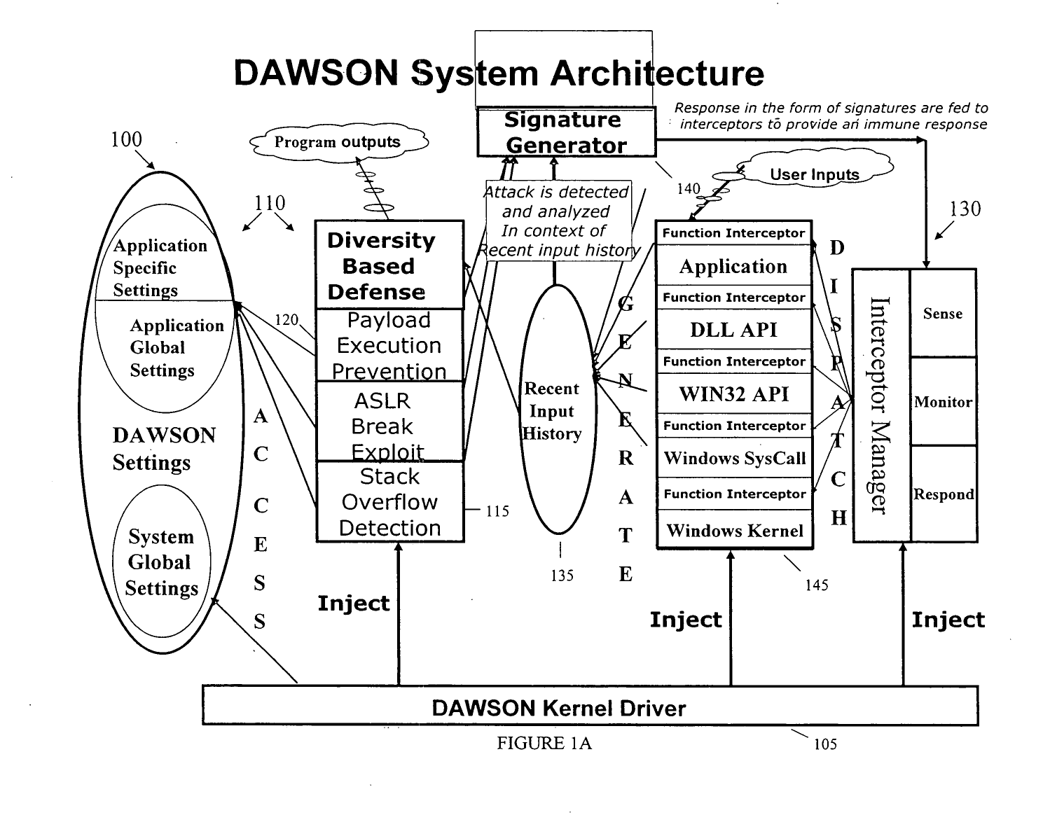

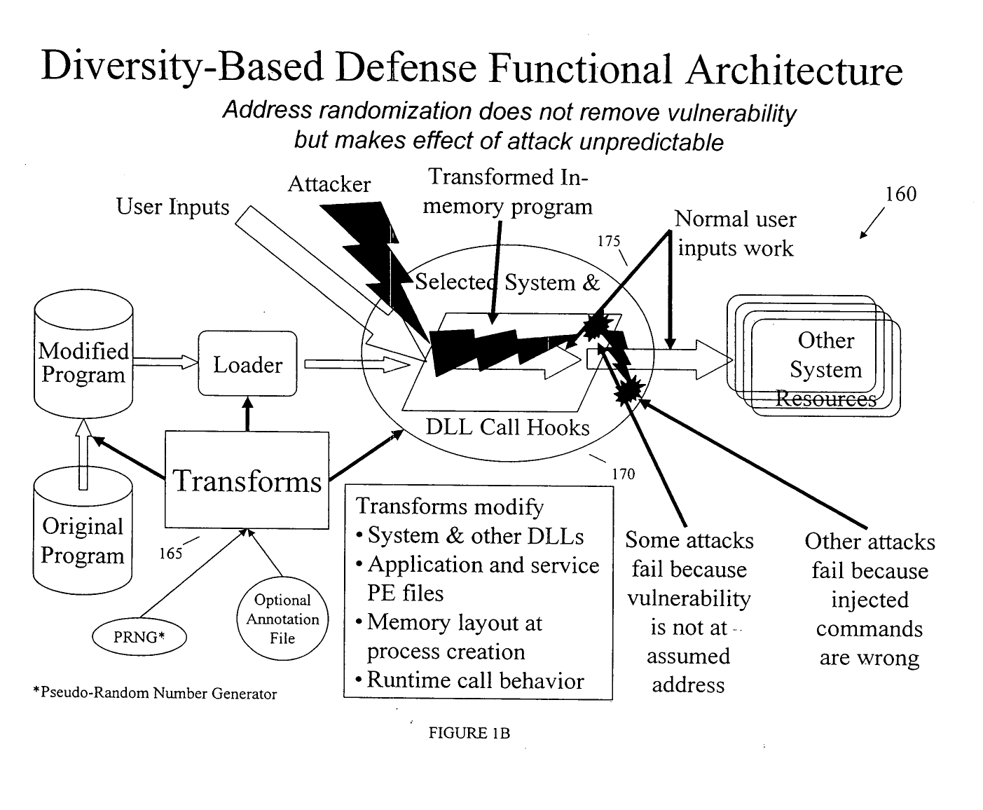

FIG. 1A is a block diagram of an exemplary high-level system architecture of the invention, generally denoted by reference numeral 100. The high-level system architecture is generally known herein as DAWSON. The DAWSON kernel driver 105 directs the DAWSON components (described below) into computer system smoothly. The kernel driver 105 is a boot time driver that assures that the various DAWSON components can be effective at the time Win32 subsystem is created and its services are started. This kernel driver injected approach does not need to modify system resources as other approaches do.

DAWSON's user mode module is implemented as user mode Dynamic Linked Libraries (DLLs) on Windows®. The user mode module injected from kernel mode does most application specific address space randomization; this makes the system very flexible to apply application specific configuration settings, comparing with a pure kernel approach that usually imposes same kind of randomizations for all applications.

On the left part of the graph, generally denoted by reference numeral 110, is the diversity based defense system, which is based on Address Space Layout Randomization (ASLR) and augmented with two extra layers including stack overflow runtime detection 115 and payload execution prevention 120 to provide capability of detecting and fail remote attacks.

On the right part of the graph is an input function interceptor based immunity response system, generally denoted by reference numeral 130, which can preserve recent input history 135 at runtime for real time signature generation (signature generator 140), and apply block or filter response for certain inputs under certain context that match an attack signature. The signatures may be expressed as a regular expression or as customized language, for example.

At the time an attack is detected, from either layer (i.e., layers 115 or 120) of the ASLR based defense system, attack data may be analyzed in the context of recent input history 135, and whenever possible, responses in the form of learned attack signatures and specific interventions (block, filter) are fed to input function interceptors 145 to provide an immune response.

The DAWSON system 100 has a capability to preserve service availability under brutal force attack by detecting an attack, tracing the attack to an input, generating signatures and deploying signatures at real time to block a further attack.

FIG. 1B is an exemplary functional block diagram of the system architecture of DAWSON, according to principles of the invention, generally denoted by reference numeral 160. The system architecture transforms and/or modifies 165 the system and other dynamic link libraries (DLLs), application and service memory image and/or PE files. A pseudo-random number generator (PRNG) provides randomization of the DLLs. By applying address randomization to selected system components and other DLLs by using call hooks 170, attacks on software applications that run under Windows® become much more unpredictable. A DAWSON protected system preserves original functionality so that normal user inputs/outputs work 175. In certain aspects, a Dawson protected system causes an attacker to fail because vulnerability is not at an address assumed by the attacker and injected commands are wrong and won't execute.

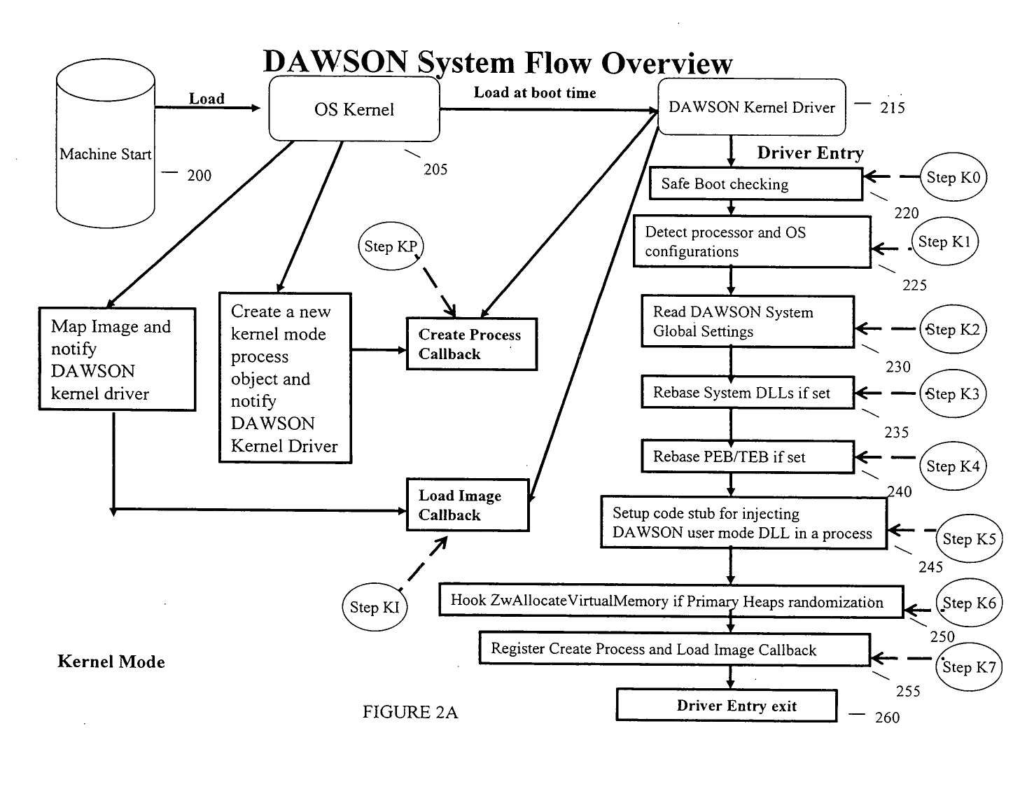

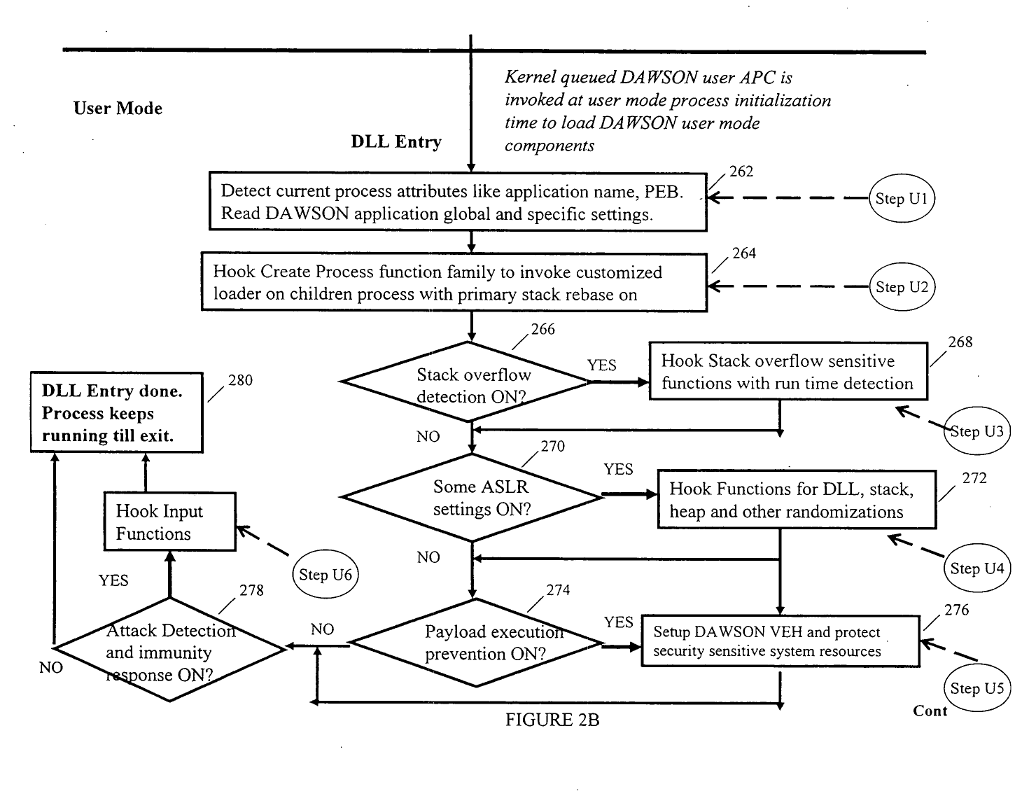

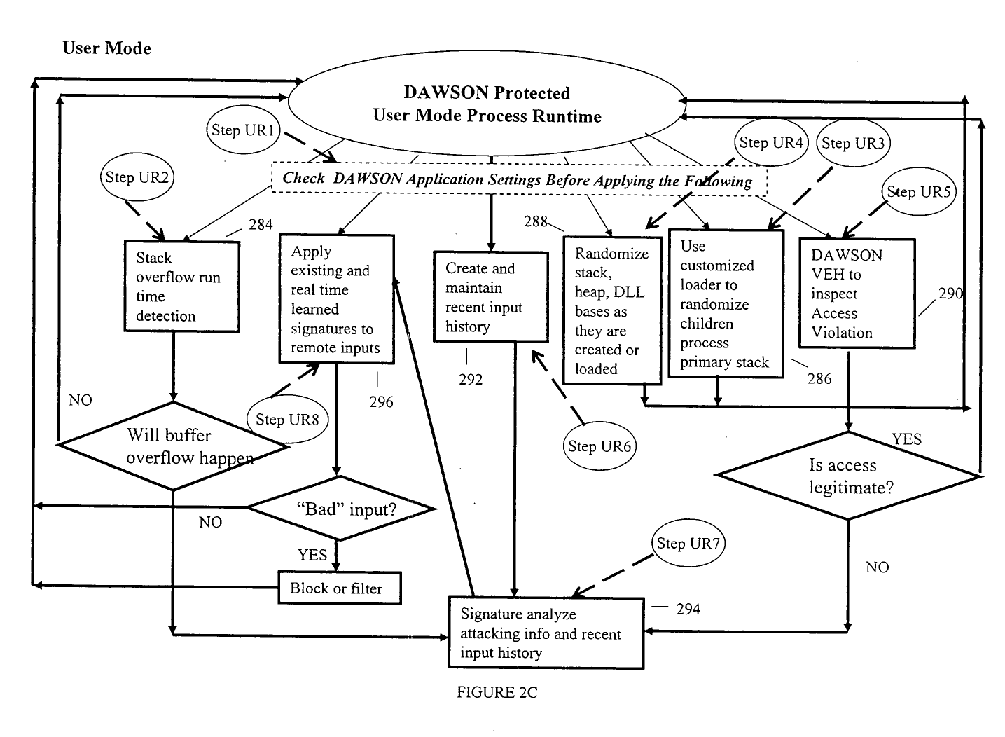

FIG. 2A is a functional flow diagram showing exemplary kernel mode activity of DAWSON kernel component, according to principles of the invention, starting at step 200. FIG. 2A shows steps of the kernel mode. FIG. 2A (and all other flow diagrams herein) may equally represent a high-level block diagram of components of the invention implementing the steps thereof. The steps of FIG. 2A (and all other flow diagrams herein) may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network, perhaps embodied in a carrier wave, which may be read by a computer.

Continuing with FIG. 2A, at step 200, a computer or computer based machine running Windows® starts and at step 205 begins to load and run the operating system (OS). Through many flow diagrams a double notation for certain steps is used to aid in some relationships. At step 215, the DAWSON kernel driver is loaded at the early stage of initialization as one of the boot time drivers. When the DAWSON kernel driver's entry code is invoked, at step 220, the DAWSON kernel driver first detects if the last driver boot attempt has failed (also known as step K0), if so, DAWSON driver will discontinue its loading and allow system restart without DAWSON and report bugs or apply updates. If not, at step 225, the DAWSON kernel driver continues to detect current machine configurations (K1), including processors type, number, attributes like PAE and NX, also current OS versions and settings. At step 230, DAWSON continues to read DAWSON System Global Settings (K2). At step 235, based on this information, the DAWSON kernel driver entry code randomizes certain items that impact every process on the machine, including System DLLs, and at step 240, rebasing PEB and TEB locations (K4).

At step 245, if User Mode Randomization is set, DAWSON kernel driver creates a code stub for injecting user mode DLL into any user processes by making the code mapped and accessible/executable in both user and kernel address space (K5). At step 250, if the primary heap randomization is set, DAWSON kernel driver hooks a kernel API ZwAllocate VirtualMemory with a wrapper for later use (K6). At step 255, the DAWSON kernel driver entry code will setup two OS kernel callbacks: CreateProcess callback and another is LoadImage callback. These callbacks are invoked at runtime whenever corresponding events happen. CreateProcess gets called whenever a process is created or deleted and LoadImage gets called whenever an image is loaded for execution. More callbacks like CreateThread callback may be used in the same manner, CreateThread callback is subsequently notified when a new thread is created and when such a thread is deleted. For simplicity not all callbacks are listed here. At step 260 the driver entry is exited.

It should be noted that the approach to inject user mode library into user address space from the kernel driver provides benefits over other prior art approaches. These benefits include:
No need to change the registry or anything else in the system, no administrative cost associated with this technique.
Effective from the early stage of a new process, whereas approaches for injecting DLL into existing process are only effective after a process is fully initialized.
Effective for all user mode processes, including low level system services. Other prior art approaches are usually only effective after OS is fully booted up, and therefore not effective for low level system services.

The DAWSON approach to inject user mode library into a user address space from the kernel driver may be used in other contexts not related to a computer security area. Some example applications include but not limited to: a memory leak detecting library to track memory usage from the start, a customized memory management system that takes over memory at the process start time, etc.

FIG. 2B is a flow diagram showing steps of a one-time set-up activity at DAWSON user mode DLL entry code, according to principles of the invention, starting at step 262.

In general, DAWSON user mode activity has two aspects: one is the one-time setup activity at DLL Entry code, shown in relation to FIG. 2B, another is the iterative activities happen in the runtime throughout a user process lifetime, described in relation to FIG. 2C. Whenever possible, a step Ux named in setup time, has its corresponding runtime step named as Step URx. For example, Step U2 is the step to setup CreateProcess hooking functions at DLL Entry time, while Step UR2 is the step to perform its runtime activity (in this case to invoke customized loader) from the wrapper when CreateProcess function gets called.

When a newly created process switches from kernel mode to user mode the first time it is created, the DAWSON user asynchronous procedure call (APC) queued from DAWSON kernel driver invokes the code to load DAWSON user module DLL from the primary thread of the process. In DAWSON's user module DLL Entry code at step 262, it detects the current running environment perhaps the application name, image path, command line, some critical system resource location like PEB, and/or reads DAWSON settings related to the current application/process, as examples. Based on all the settings retrieved, the DAWSON user mode DLL entry hooks respective functions to accomplish certain features at runtime. At step 264, the CreateProcess function family is hooked if the to be spawned child process is set to do primary stack rebase (step U2). At step 266, a check is made if stack overflow detection is on. If so, then at step 268, the stack overflow sensitive function is hooked (step U3). At step 270, a check is made if any ASLR settings are on; if so, at step 272, functions responsible for DLL mapping, stack location and heap base are hooked. At step 274, a check is made whether payload execution prevention is on. If so, at step 276, DAWSON-provided Vector Exception Handler (VEH) function is added (Step U5). (Note: VEH is a type of Exception Handler “EH” used in relation to Windows® XP, but this example is simply using VEH to explain certain principles, but these principles are generally germane to other Exception Handlers in other operating systems, especially other versions of Windows®, for which a DAWSON Exception Handler may be provided). At step 278, a check is made whether attack detection and immunity response is on. If so, then input functions such as network socket APIs are hooked (Step U6). At step 280, the process completes.

FIG. 2C is a flow diagram showing steps for iterative activities that happen during runtime throughout a user process lifetime based on the setup for the user application at DLL Entry code, according to principles of the invention.

DAWSON runtime activity is generally driven by original application program logic, in other words, DAWSON runtime responds when certain application program events happen. By way of example, at step 284, when some stack overflow sensitive functions are invoked (Step UR2), a run time stack check starts. The sensitive functions typically include the memcpy, strcpy and printf function families, where much vulnerability typically arises. Usually the runtime checking is quick and applies only to buffers that reside in the stack. When an overflow is detected, it has the complete context and an overflow usually can be prevented before it happens.

At step 286, when a current process is trying to invoke a child process, the wrapper can invoke customized loader to create the process instead of using the normal loader (Step UR3). The customized loader will bypass the Win32 API to invoke lower level API to create primitive process object and thread object, allocate stack memory in randomized location and assign it to the primary stack. Also from the customized loader it can do something optional, like sharing a set of statically linked DLLs with other processes.

At step 288, at the “core” of ASLR implementation, when a DLL is dynamically loaded, a new thread is created, a new heap is created or heap blocks allocated, DAWSON runtime code randomizes corresponding memory objects when they are created (Step UR4).

At step 290, protection of “critical system resources” from access by remote payload execution primarily occurs (Step UR5). Here the DAWSON Vector Exception Handler does runtime authentication. By using a register repair based technique (Step UR5-R), the fine-grained protection mechanism offers maximum efficiency by only authenticating to-the-point check (precise to 4 bytes) and not causing unnecessary and too many exceptions, as page-based mechanism could do.

At step 292, provide runtime attack signature generation and immunity response (Step UR6). DAWSON runtime code from remote input function wrappers creates and maintains recent input history. Context corresponding to the inputs like function name, thread, stack context is saved also. At step 294, this maintained and saved information is used to analyze and generate attack signatures when attack is detected (Step UR7). At step 296, once the signature is generated, it may be applied at run time to the earlier time in the input point and block further similar attacks (Step UR8).

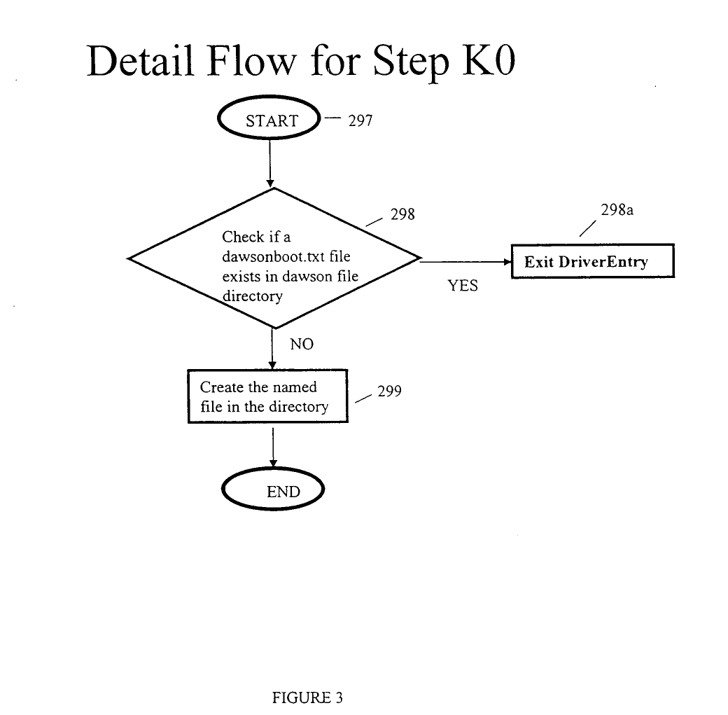

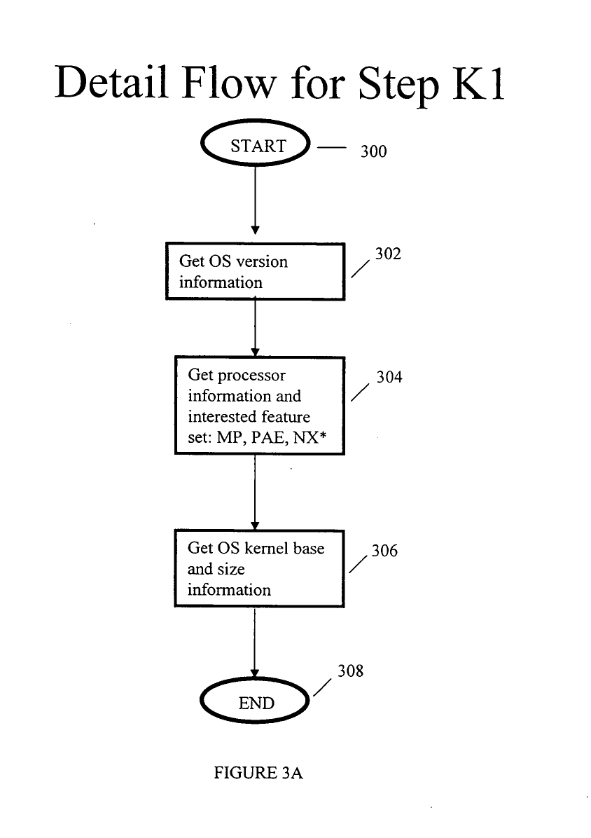

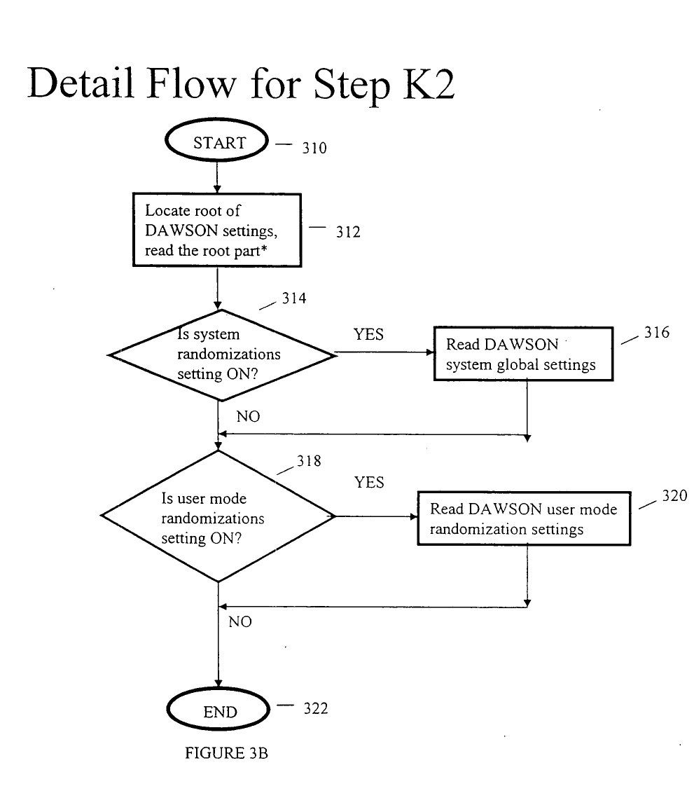

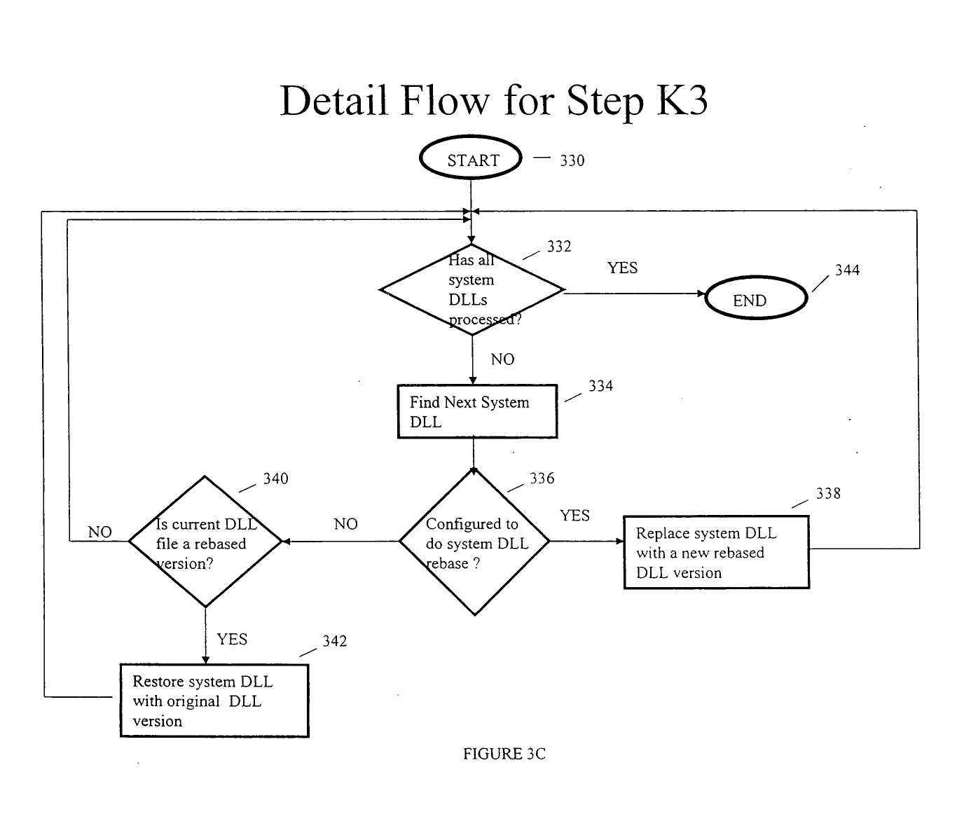

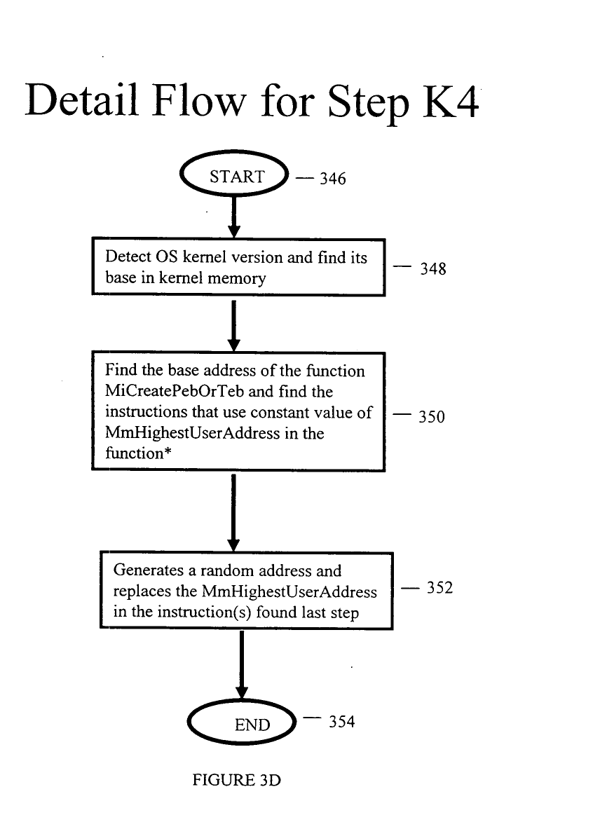

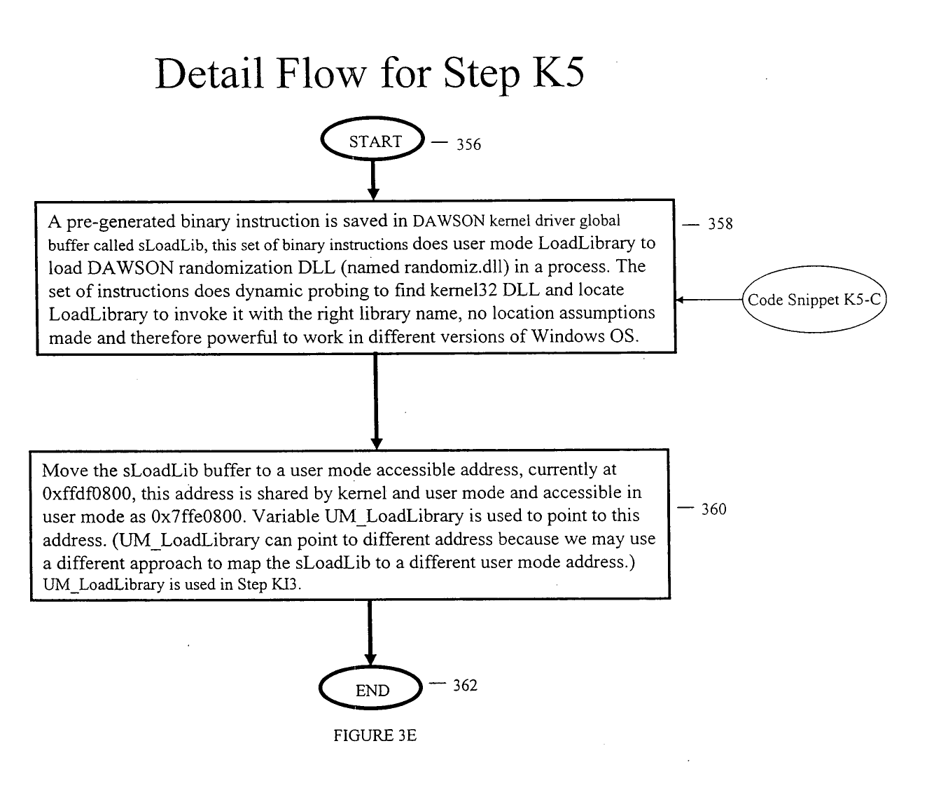

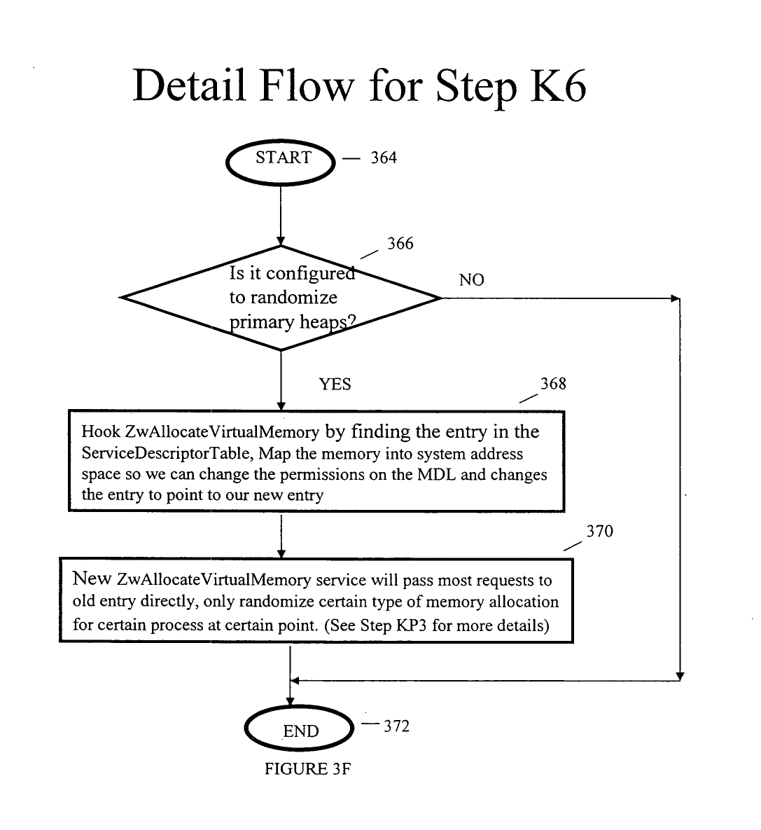

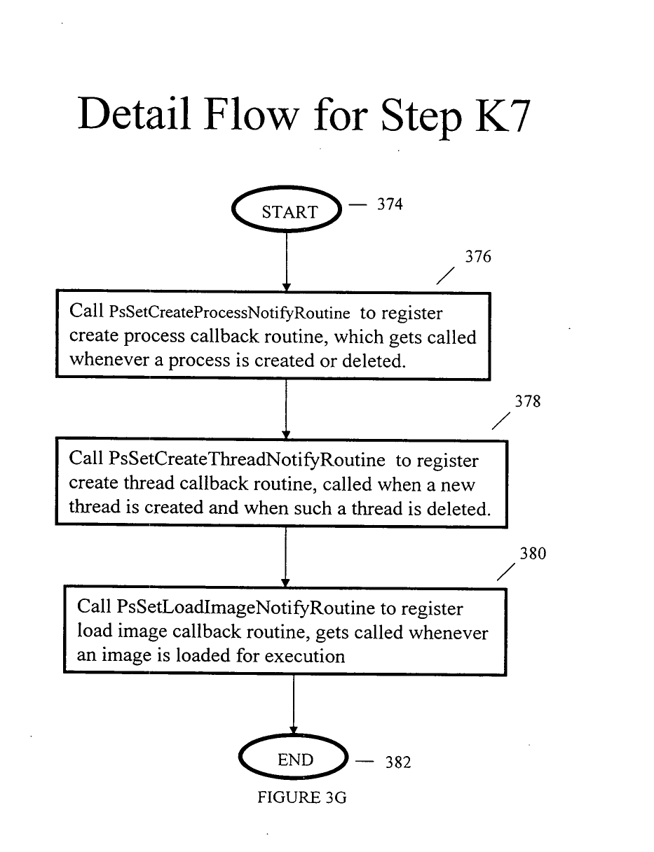

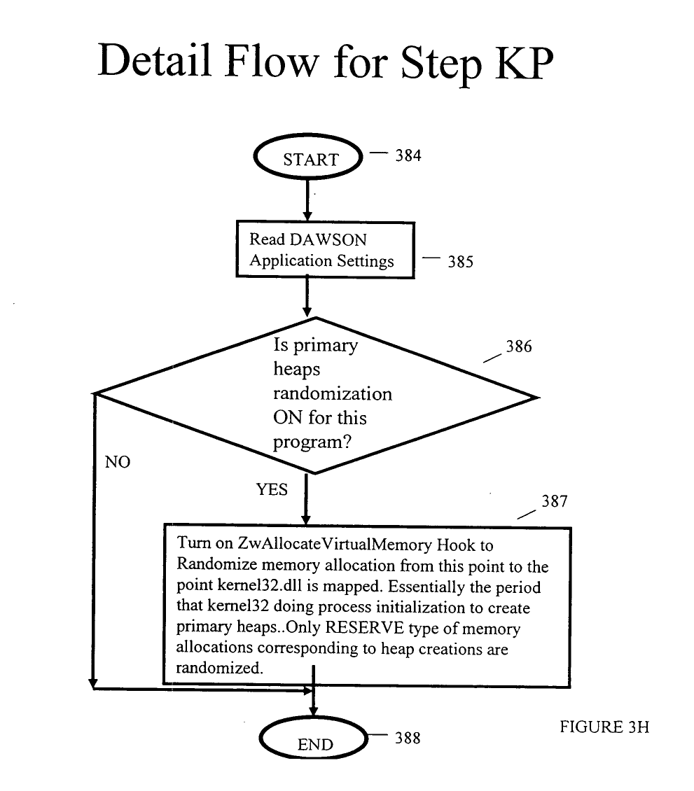

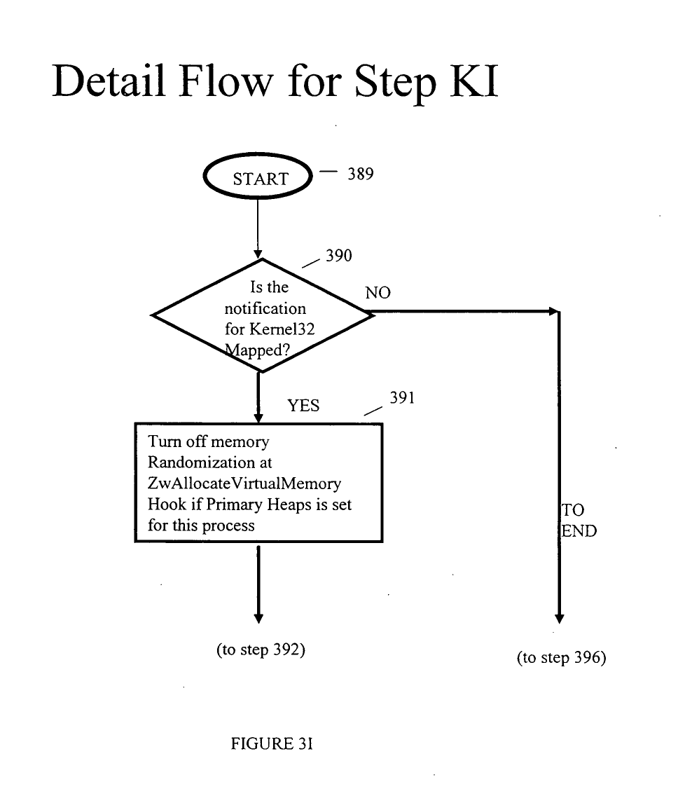

FIG. 3 is a flow diagram showing more detailed steps of step K0 of FIG. 2A, according to principles of the invention, starting at step 297. As with any other kernel driver, any unexpected problem or bug in the driver can bring system down or cause the host to fail to boot properly. The DAWSON kernel driver is typically loaded in the system boot phase, so a bug in the driver encountered during the load phase, or any unexpected events due to hardware/software incompatibility may cause the system to reboot repeatedly. To prevent this unfortunate event, DAWSON includes fail-over protection.

When the system loads the DAWSON driver, at step 298, the DAWSON driver checks to see if a “DawsonBoot.txt” file is already present. If not, at step 299, a file called DawsonBoot.txt under C:\DAWSON is created and the process exits. In the case of a successful startup, a program called DAWSONGUI (for example) scheduled as a startup program that should automatically run after a user login cleans up the boot file.

In the case of an unsuccessful startup, DAWSONGUI will not have a chance to clean it, so the host reboots and attempts to load the DAWSON kernel driver again. However, when the driver detects the residual file, at step 298, due to last failed boot, an error condition is assumed, and at step 298a the original system is loaded and the process exits. The machine should boot successfully into the original system image on the second reboot. When the machine successfully boots the second time, the user will have the chance to run the system while waiting for an updated version before enabling DAWSON protection again.

The same DAWSONGUI scheduled to run every reboot can randomize system DLLs offline and save the randomized versions in a DAWSON-protected storage, these randomized system DLLs may be used in Step K3 (FIG. 3C) by DAWSON kernel driver to provide a different set of system DLL randomizations every reboot. To reduce/eliminate memory fragmentation impact, these system DLLs usually randomized in the neighborhood of the same address base without causing conflicts, while still providing unpredictable randomization because 1) the address base is different and 2) the order of the system DLLs are different each time.

DAWSONGUI is also the management console for administrator to specify/change protection settings, response policies, check system health statistics.

FIG. 3A is a flow diagram showing additional exemplary steps of step K1 of FIG. 2A, according to principles of the invention, starting at step 300. In the drawing of FIG. 3A, MP refers to Multiple Processors, PAE refers to Physical Address Extension and NX refers to NoneXecutable. At step 302, the OS version is obtained. At step 304, processor information and certain feature set may be obtained such as MP, PAE and NX. At step 306, the OS kernel base address and size information is acquired. At step 308, the process ends.

This information acquired by the steps of FIG. 3A is needed to determine the exact OS kernel module name on Windows®, and then use this actual name to find its base and size information, and subsequently, this information is used to patch the instruction(s) for PEB/TEB randomization. Also a routine is developed to get/set a page's executable bit in the page table for a given page. This is necessary for the kernel injecting user mode library approach to work when the page that has the code stub needs executable privilege to run. This is usually needed when hardware has PAE and NX features on. “Patch” is a general term defined as the action to overwrite a piece of a function in memory or image file to change certain behavior of the function.

FIG. 3B is a flow diagram showing additional exemplary steps of step K2 of FIG. 2A, according to principles of the invention, starting at step 310. At step 312, the root of DAWSON settings is located from where the root part is read. At step 314, a check is made to determine whether the system randomization setting is on. If so, at step 316, the DAWSON system global settings are read.

At step 318, a check may be made whether the user mode randomization setting is on. If so, at step 320, the DAWSON user mode randomization settings are read. At step 322, the process ends.

DAWSON features are configurable and can be made effective at run time or boot time. For example:

```
    Location and default value:
    [HKEY_LOCAL_MACHINE\SYSTEM\
CurrentControlSet\Services\dawsonkd\Configurations]
    “KMRANDOM”=dword:00000001
    “UMRANDOM”=dword:00000001
    Description:
    // KMRANDOM to turn on/off system level randomization
    // UMRANDOM to turn on/off application level randomization
```

Features that have system wide impact are usually effective upon reboot; they may be put under:

[HKEY_LOCAL_MACHINE\SYSTEM\CurrentControlSet\Services\
dawsonkd\sysconf]

While features that are applied to a particular application at run time are usually put under:

[HKEY_LOCAL_MACHINE\SYSTEM\CurrentControlSet\
Services\dawsonkd\appconf]

Applications take the default feature settings under appconf unless the same setting is set under its own subkey. This flexibility enables applications to run with different set of randomization settings to achieve security, stability and performance balance.

To balance maximum security and maximum performance, DAWSON turns on default features considered “critical” and has a minimum performance impact at global level, but leaves the individual application features configurable in its own settings. It is recommended to change specific application settings rather than the global settings to avoid system level impact.

An example follows:

To specify settings that are different from settings in the global level, a subkey is created under

[HKEY_LOCAL_MACHINE\SYSTEM\CurrentControlSet\
Services\dawsonkd\Configurations\APPCONF]

With the name the same as the program file name:

For example, the following registry set customized feature settings for notepad.exe process set:
Application level randomization logging ON for notepad.exe.
Application level PEB Loader protection off for notepad.exe.

```
    [HKEY_LOCAL_MACHINE\SYSTEM\CurrentControlSet\
Services\dawsonkd\Configurations\APPCONF\notepad.exe]
    “LOG”=dword:00000001
    “PEBLDR”=dword:00000000
```

### Customized settings can go even further with finer grained application configurations used when necessary, with criteria on more process properties like ImagePath, command line parameters, for example, given the above example,

```
        “ImagePath” = c:\windows\notepad.exe
And,
        “ImagePath” = c:\windows\system32\notepad.exe
```

Could have different settings for the same program notepad.exe, when started from different path:

```
        “CommandLine” = c:\windows\notepad.exe
And,
        “CommandLine” = c:\windows\notepad.exe mytest.txt
```

Can have different settings for same program from the same path but with different command line parameters.

FIG. 3C is an exemplary flow diagram showing additional exemplary steps of step K3 of FIG. 2A, starting at step 330. At step 332, a check is made if all system DLLs have been processed. If so, then the process exits at step 344. Otherwise, at step 334 the next system DLL is located. At step 336, a check is made if the found DLL is configured to a system DLL rebase. If so, then at step 338, the original system DLL is replaced with the rebased DLL version and processing continues at step 332. If however, at step 336, the DLL is not configured to for system DLL rebase, then at step 340, a check is made if the current DLL file is a rebased version. If not, then processing continues at step 332. Otherwise, if the current DLL is a rebased DLL, then at step 342, the original DLL is restored and processing continues at step 332.

FIG. 3D is an exemplary flow diagram showing more detailed exemplary steps of step K4 of FIG. 2A, starting at step 346. At step 348, Windows OS kernel (e.g., ntoskrnl.exe) version is detected and ntoskrnl.exe base may be located in kernel memory. At step 350, the base address of function MiCreatePebOrTeb may be found. Also, the instruction(s) that use the constant value of MmHighestUserAddress in the function may be found. The instructions are in a form similar as:
mov eax,[nt! MmHighestUserAddress (80568ebc)]
and MmHighestUserAddress is an exported variable that is easy to access.

A general disassembly based approach can be used to find this function and its interested instructions, or even simpler, a small table that contains the offsets of the function and interested instructions from the base of ntoskrnl.exe maybe used to locate the instructions, because for a certain ntoskrnl.exe version the offsets remains constant. Since DAWSON already got ntoskrnl.exe base address dynamically at step 306, the real address for the instructions can be easily found at base+offset. At step 352 a random address may be generated to replace the MmHigestUserAddress in the instruction(s) found in step 350. At step 354, the process ends.

When a process is created, loader loads executable image and Process Environment Block (PEB) is created. When a thread is created, a Thread Environment Block (TEB) is created. Inside TEB, a pointer to PEB is available. The PEB contains all user-mode parameters associated with the current process, including image module list, each module's base address, pointer to process heap, environment path, process parameters and DLL path. Most importantly, the PEB contains Load Data structure, which keeps link lists of base address of the executable and all of its DLLs. TEB contains pointers to critical system resources like stack information block that includes stack base, exception handlers list. The PEB and TEB contain critical information for both defender and attacker, so one of the first few things we are doing is to randomize the locations of the PEB/TEB from kernel driver at system init time so attacker has no access to these structures at the default locations; later in Step UR5 another approach is shown to block illegitimate access to these structures through other techniques.

FIG. 3E is an exemplary flow diagram showing additional exemplary steps of step K5 of FIG. 2A, starting at step 356. The set of instructions does dynamic probing to find kernel32 DLL and locate LoadLibrary to invoke it with the right library name, no location assumptions are made and therefore this is powerful to work in different versions of Windows OS. UM_LoadLibrary can point to a different address because a different approach may be used to map the code to a different user mode address.

At step 358, in DAWSON kernel driver's entry code, the code stub that calls the user mode LoadLibrary, is saved in the kernel driver global buffer, maybe called sLoadLib. At step 360, the sLoadLib buffer may be moved to a user mode accessible address or a page shareable with user mode. At step 388, in the LoadlmageCallBackRoutine, when a new process is loading kernel32.dll, a call to KelntializeApc is made to initialize a user APC routine and calls KelnsertQueueApc to insert DAWSON user APC to the APC queue. The process ends at step 362.

The following is pseudo code, known as sLoadLib, and illustrates step 358 of FIG. 3E and provides additional detailed steps. The pseudo code sLoadLib is exemplary and may be written in different languages or possibly using different instructions, as a skilled artisan would recognize:
Extract PEB from fs register
Extract PEB_LDR_DATA from PEB
Get the header of LoadModuleList from PEB_LDR_DATA
Retrieve Kernel32 base from the node in LoadModuleList
Parse PE header of kernel32
Locate kernel32 EAT table
Locate the Names Table from EAT table
Search Names Table until LoadLibrary is found and extract its ordinal
Use the ordinal to locate LoadLibary function address from address table
Invoke LoadLibrary to load randomiz.dll

FIG. 3F is a flow diagram showing more detailed exemplary steps of step K6 of FIG. 2A, according to principles of the invention, starting at step 364. At step 366, a check is made whether the system is configured to randomize primary heaps. If not, the process ends at step 372. Otherwise, if so, at step 368, ZwAllocateVirtualMemory is hooked by finding the entry in the ServiceDescriptorTable, and mapping the memory into the system address space so the permissions on the MDL can be changed, with the entry pointing to the new entry location. At step 370, a new ZwAllocateVirtualMemory service passes most requests to old entry directly; only randomizes certain type of memory allocation for certain process at certain point. The process exits at step 372.

FIG. 3G is a flow diagram showing more detailed exemplary steps of step K7 of FIG. 2A, according to principles of the invention, starting at step 374. At step 376, PsSetCreateProcessNotifyRoutine is called to register and create a process callback routine, which gets called whenever a process is created or deleted. At step 378, PsSetCreateThreadNotifyRoutine is called to register a create thread callback routine, called when a new thread is created and when such a thread is deleted. At step 380, PsSetLoadlmageNotifyRoutine may be called to register load image callback routine, and may be called whenever an image is loaded for execution. At step 382, the process exits.

FIG. 3H is a flow diagram showing more detailed exemplary steps of step KP of FIG. 2A, according to principles of the invention, starting at step 384. At step 385, DAWSON application settings are read. At step 386, a check may be made whether primary heaps randomization is on. If not, then the process exits at step 388. Otherwise, if on, at step 387, ZwAllocateVirtualMemory hook is enabled to randomize memory allocation from this point to the where point kernel32.dll is mapped. Essentially that's the period that kernel32 is doing process initialization to create primary heaps. Only RESERVE type of memory allocations corresponding to heap creations is typically randomized.

FIG. 3I is a flow diagram showing more detailed exemplary steps of step K1 of FIG. 2A, according to principles of the invention, starting at step 389. At step 390, a check is made whether the notification for kernel32 is mapped. If not, processing exits at step 396. Otherwise, if mapped, at step 391, memory randomization is turned off at ZwAllocateVirtualMemory hook, if Primary Heaps is set for this process. At step 392, a check is made if processor NX is enabled. If not, then processing continues at step 394. Otherwise, if enabled, at step 393, the execute bit in the page table for the page where the stub UM_LoadLibrary resided is enabled. At step 394, in LoadImageCallBack routine, when a new process is loading kernel32.dll, call KeInitializeApc to initialize a user APC routine (which is usually UM_LoadLibrary), and call KelnsertQueueApc to insert DAWSON user APC to the APC queue. At step 395, when the new process is switched to user mode at process initialization time, UM_LoadLibrary is called and loads DAWSON's user mode randomization DLL (randomiz.dll), and continues DAWSON user mode randomization, e.g., in Step U1.

The following is a snippet code example for KI-C:

```
VOID ImageCallBack(
  IN PUNICODE_STRING FullImageName,
  IN HANDLE ProcessId, // where image is mapped
  IN PIMAGE_INFO ImageInfo
  )
{
        UNICODE_STRING u_targetDLL;
        PEPROCESS ProcessPtr=NULL;
        PsLookupProcessByProcessId((ULONG)ProcessId,&ProcessPtr);
        if(!ProcessPtr)
            return;
        // For injecting user mode DLL
        RtlInitUnicodeString(&u_targetDLL,L“\\WINDOWS\\system32\\kernel32.dl
1”);
            if (RtlCompareUnicodeString(FullImageName,
&u_targetDLL,TRUE) == 0)
            {
                {//both need to be ON for hardware supported NX
                if(Ke386Pae && Ke386NoExecute)
                    //Enable EX for the page so stub can run in user mode
        MmSetPageProtect(ProcessPtr,(PVOID)UM_LoadLibrary,PAGE_EXECUTE_READ);
                }
                AddUserApc(ProcessId,NULL);
            }
        }
        VOID AddUserApc(IN HANDLE hProcessId,IN HANDLE hThreadId)
        {
            PEPROCESS ProcessPtr=NULL;
            if (!gb_Hooked)
                return;
            PsLookupProcessByProcessId((ULONG)hProcessId,&ProcessPtr);
            if(!ProcessPtr)
                return;
            KeAttachProcess(ProcessPtr);
        DawsonQueueUserApcToProcess(hProcessId,PsGetCurrentThreadId( ));
            KeDetachProcess( );
        }
```

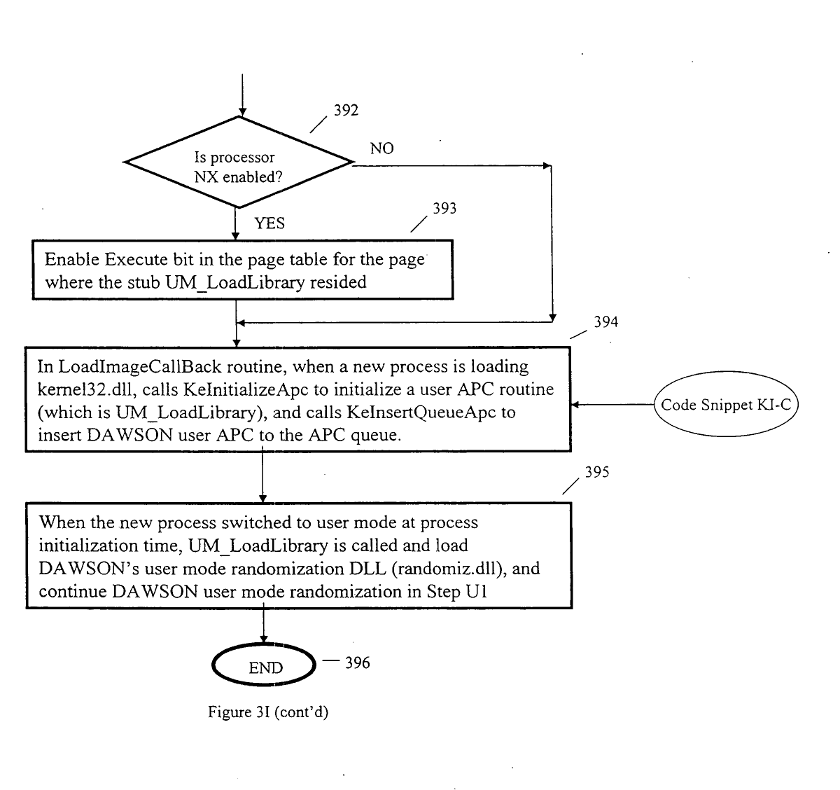

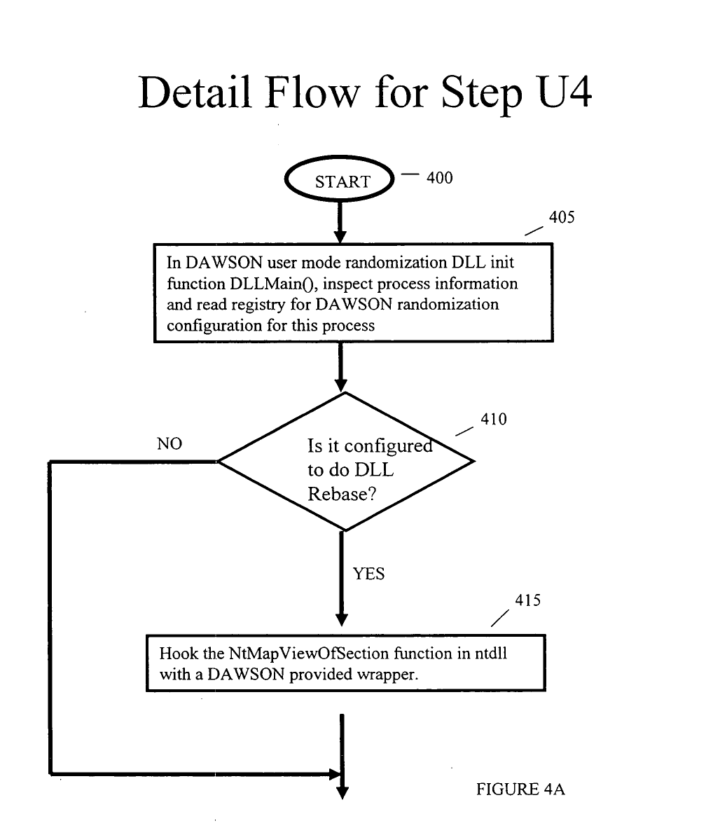

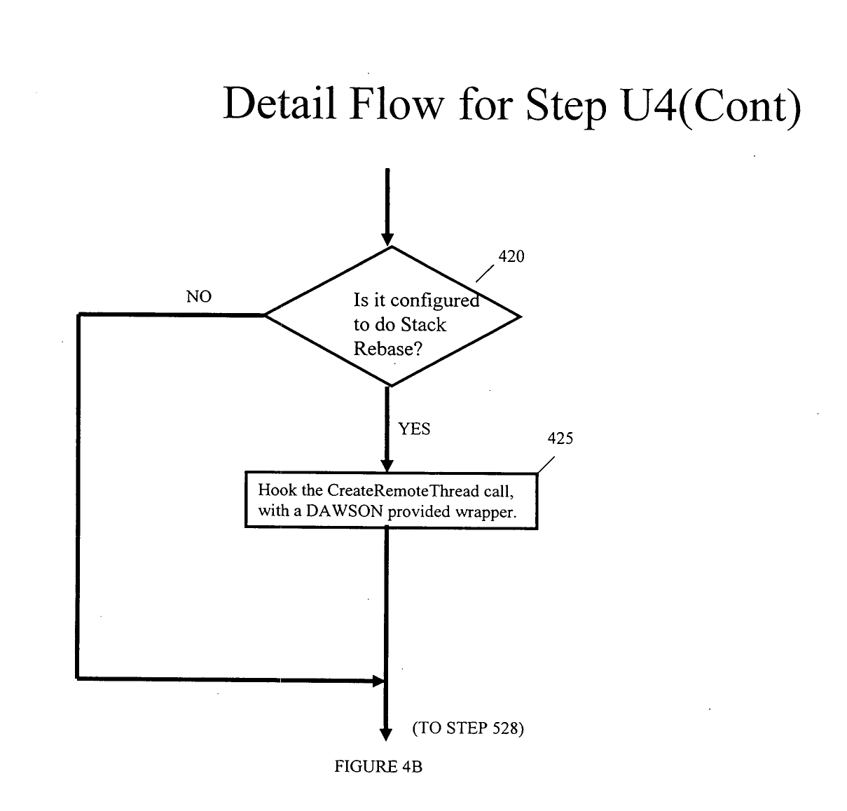

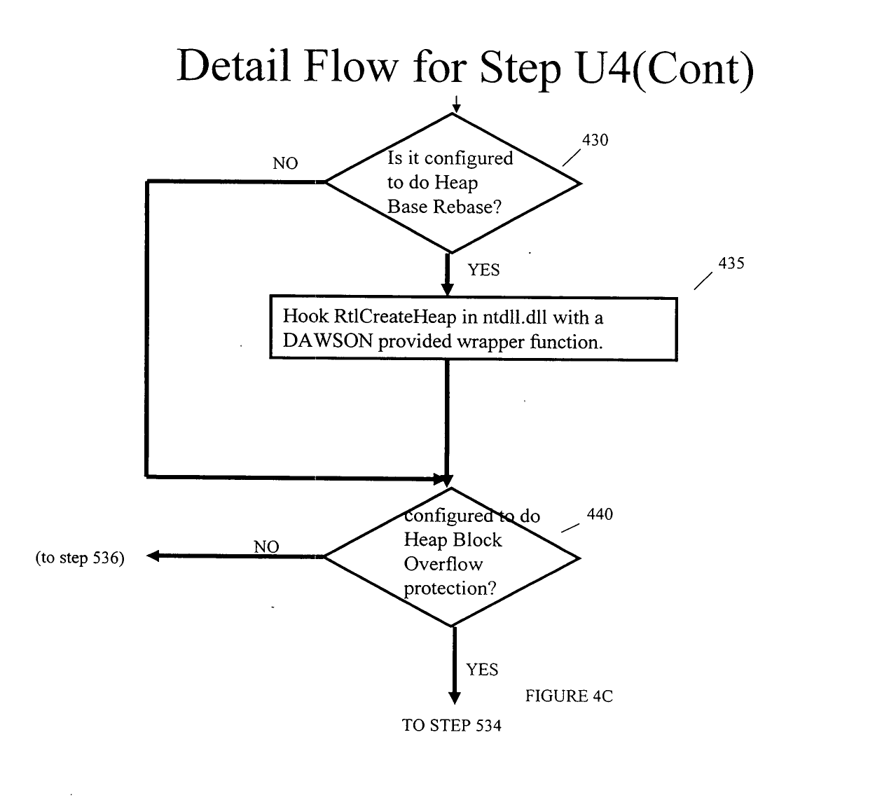

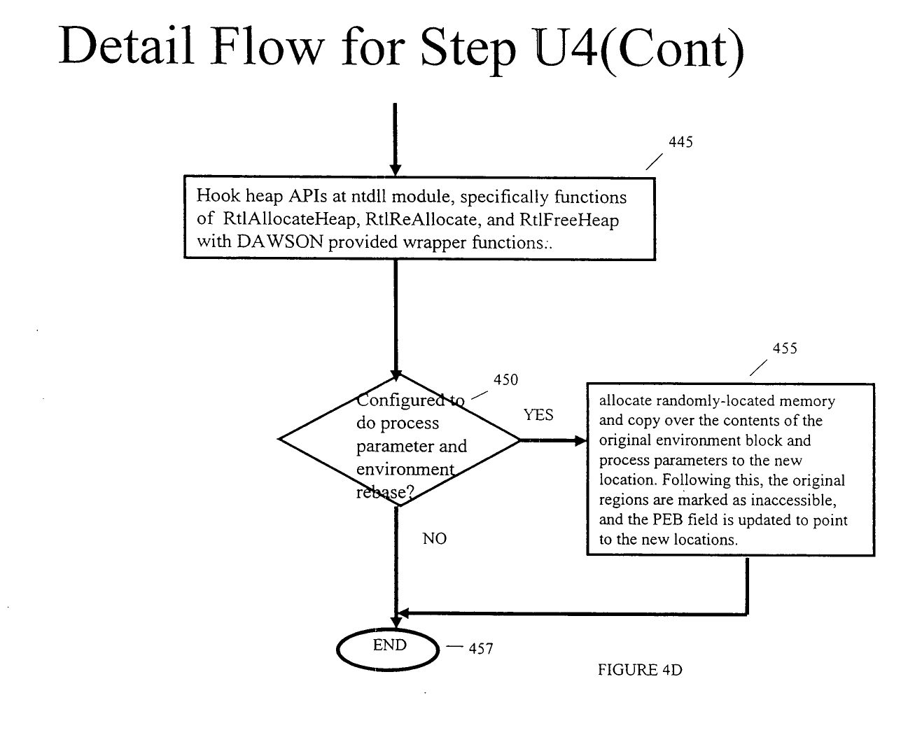

FIGS. 4A-4D are exemplary flow diagrams showing additional exemplary steps of step U4 of FIG. 2B, according to principles of the invention, starting at step 400. At step 405, in the DAWSON user mode randomization DLL init function DLLMain( ), inspect the process information and read registry for DAWSON randomization configuration for this process. At step 410, a check is made whether the process is configured to do DLL rebasing. If not, by-pass step 415. If so, at step 415, hook the NtMapViewOfSection function provided by ntdll with a DAWSON provided wrapper, the wrapper modifies the parameter that specifies the base address of the DLL mapping address when invoked. At step 420, a check is made if the process is configured to do stack rebasing. If not, step 425 is by-passed. If so, at step, 425, hook the CreateRemoteThread call, which in turn is typically called by CreateThread call, to create a new thread. When invoked, the start address parameter is replaced with the address of a new DAWSON “wrapper” function. At step 430, a check is made if the process is configured to do Heap base rebasing. If not, then step 435 is by-passed. If so, then at step 435, hook RtlCreateHeap in ntdll.dll with a DAWSON wrapper function. In the wrapper function, memory is allocated of the requested size on a random address. The random allocated memory address is provided to the parameter of RtlCreateHeap that should contain the base address of the new heap before making the call to RtlCreateHeap. At step 440, a check is made whether the process is configured to do heap block overflow protection. If not, then processing continues at step 450. Otherwise, if configured to do heap block overflow protection, then at step 445, hook heap APIs at ntdll module including functions RtlAllocateHeap, RtlReAllocate and RtlFreeHeap. A wrapper is provided so that at runtime individual requests for allocating memory blocks are subsequently handled by the wrapper and guards may be added around real user blocks. Random cookies that may be embedded in the guards may also be checked for overflow detection. At step 450, a check is made to determine if configuration is actively set to process parameter and environment variable block rebasing. If not, then the process ends at step 457. Otherwise, if configuration is actively set to process parameter and environment rebasing, then allocation of randomly allocated memory occurs. Contents of the original environment block and process parameters are copied to the new randomly allocated memory. The original regions are marked as in accessible, and the PEB field is updated to point to the new locations. The process exits at step 457.

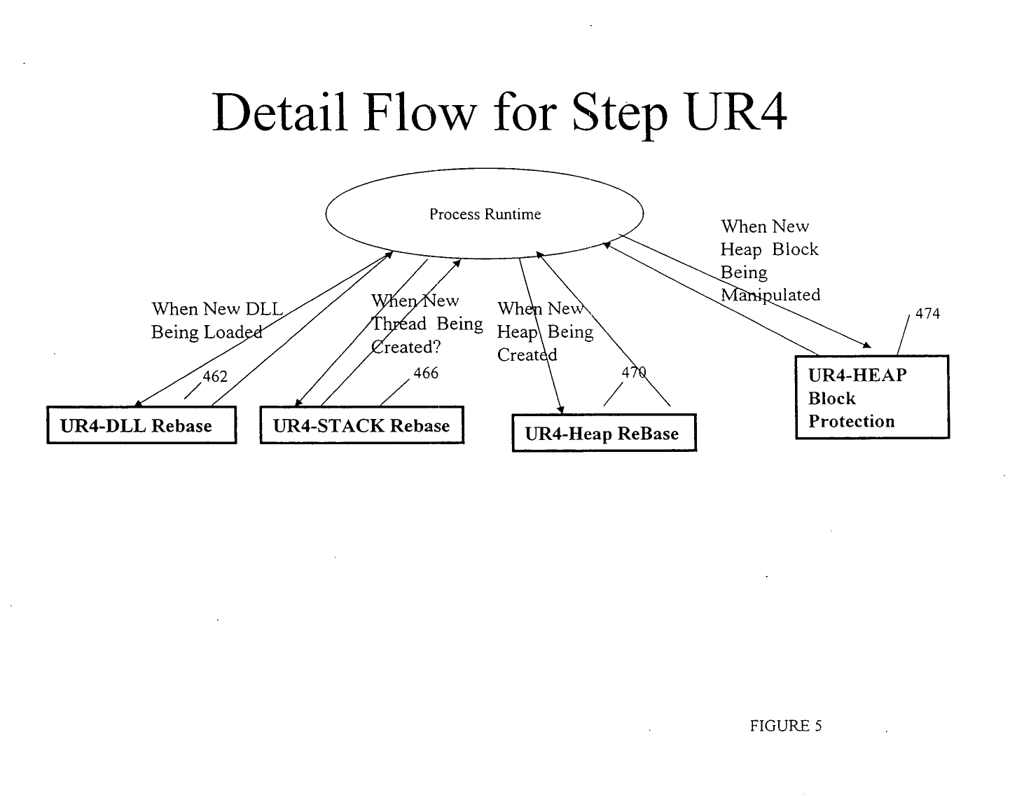

FIG. 5 is a relational flow diagram showing additional exemplary steps of step UR-4 of FIG. 2C. The steps are iterative and DAWSON wrapper code takes corresponding actions when certain events happen in program. In particular, while a process is running, when a new DLL is being loaded, at step 462 the DLL is rebased. When a new thread is being created, at step 466, the stack for the thread is rebased. When a new heap is being created, at step 470, the heap base is rebased. When a heap block is being manipulated, at step 474, heap block protection is activated.

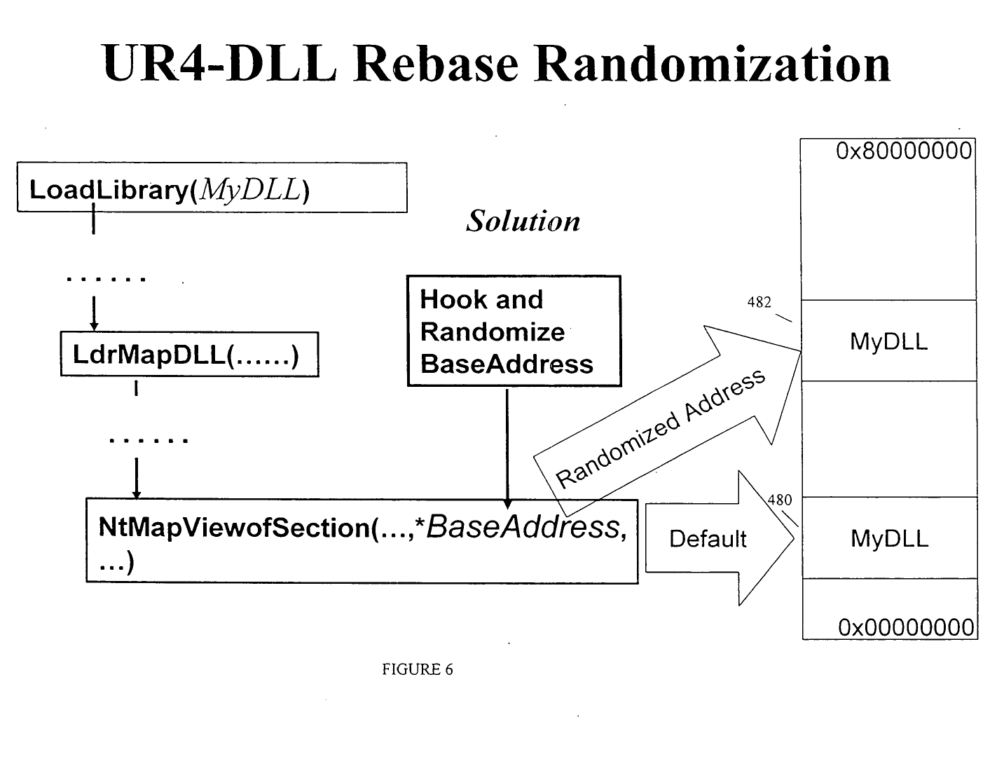

FIG. 6 is a relational flow diagram illustrating step UR-4 of FIG. 2C, in particular, a DLL rebase randomization, according to principles of the invention. When NtMapViewOfSection is invoked in the program, the NtMapViewOfSection wrapper setup in step 415 modifies the parameter that species the base address of the DLL mapping address before calling original NtMapViewOfSection function.

Illustratively, the DLL is rebased from an original base address 480 to a new base address 482.

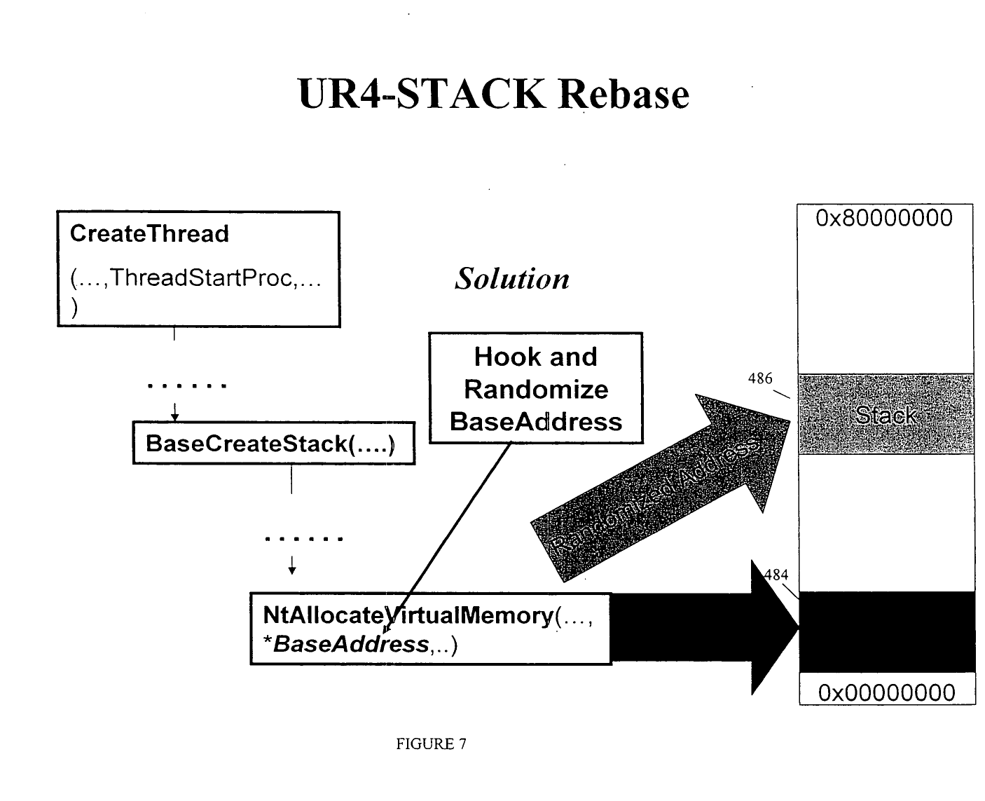

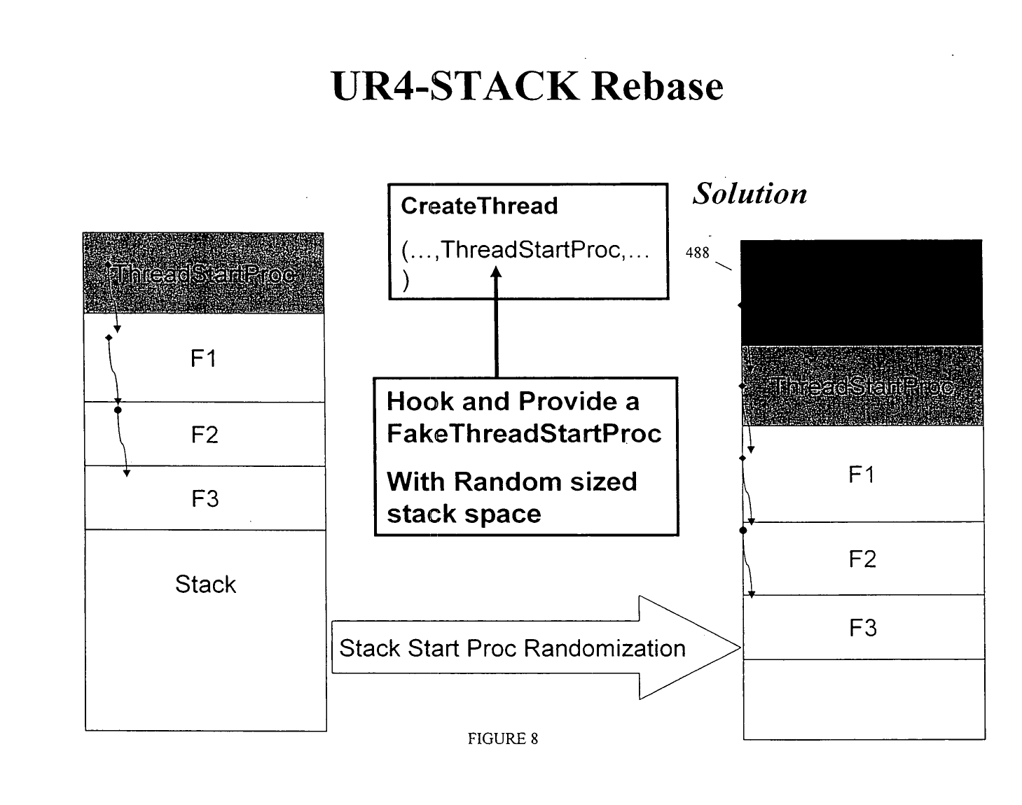

FIGS. 7 and 8 are exemplary relational flow diagrams further illustrating step UR-4 of FIG. 2C; in particular, a stack rebasing, according to principles of the invention. Stack rebasing typically applies two levels of stack randomization including stack base randomization through hooking stack space function (FIG. 7), where the stack base is randomized form an original location 484 to a randomized location 486. This level of randomization is done inside the CreateRemoteThread wrapper function that is setup at step 425 by randomizing the base address parameter for NtAllocateVirtualMemory that is invoked by CreateRemoteThread from the same thread. The second is a stack frame randomization by inserting fake Thread_START_ROUTINE 488 (FIG. 8). This level of randomization is done inside the CreateRemoteThread wrapper function that is setup at step 425 by replacing the start routine parameter with DAWSON provided start routine, when DAWSON provided start routine starts executing, it first allocates a randomized size memory at the beginning of stack so the beginning address of real stack frame is at a randomized address.

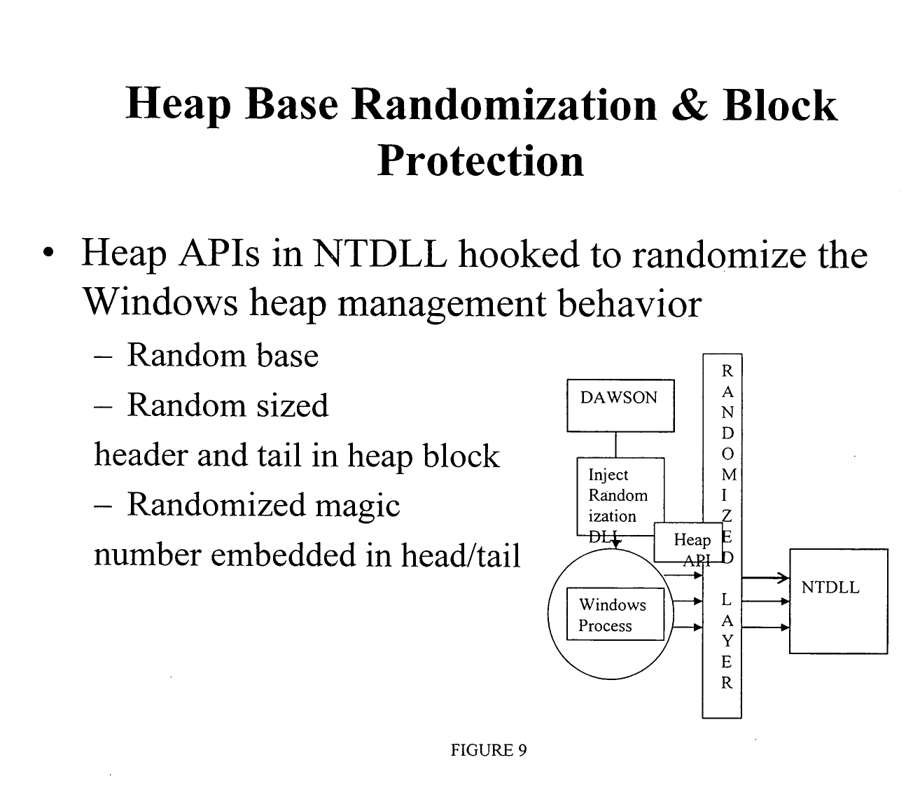

FIG. 9 is an illustration further illustrating step UR-4 of FIG. 2C, in particular, heap base randomization and heap block protection, according to principles of the invention. The illustration shows a randomizing layer for heap APIs.

FIG. 9 shows additional steps of step UR-4 of FIG. 2C, showing the runtime behavior of the heap APIs wrappers setup at step 435 and at step 445. By way of example, the step of UR-4 of FIG. 2C may have a DAWSON provided wrapper for the following function and provide a randomized base for a newly created heap:

| NTAPI RtlCreateHeap( | |
|---|---|
| Unsigned long | Flags, |
| PVOID | Base, |
| Unsigned long | Reserve, |
| Unsigned long | Commit, |
| BOOLEAN | Lock, |

PRTL_HEAP_DEFINITION RtlHeapParams)

In the wrapper function, it allocates the memory of requested size on a random address and provides the allocated memory address to the parameter of RtlCreateHeap that should contain the base address of the newly created heap before making the call to original RtlCreateHeap function.

Other heap APIs at ntdll module specifically functions of RtlAllocateHeap, RtlReAllocate, and RtlFreeHeap are hooked and provided with DAWSON wrapper function at step 445, at runtime, individual requests for allocating and manipulating memory blocks go through DAWSON wrappers, and guards can be added around the real user blocks and random cookies embedded in the guards can be checked for overflow detection.

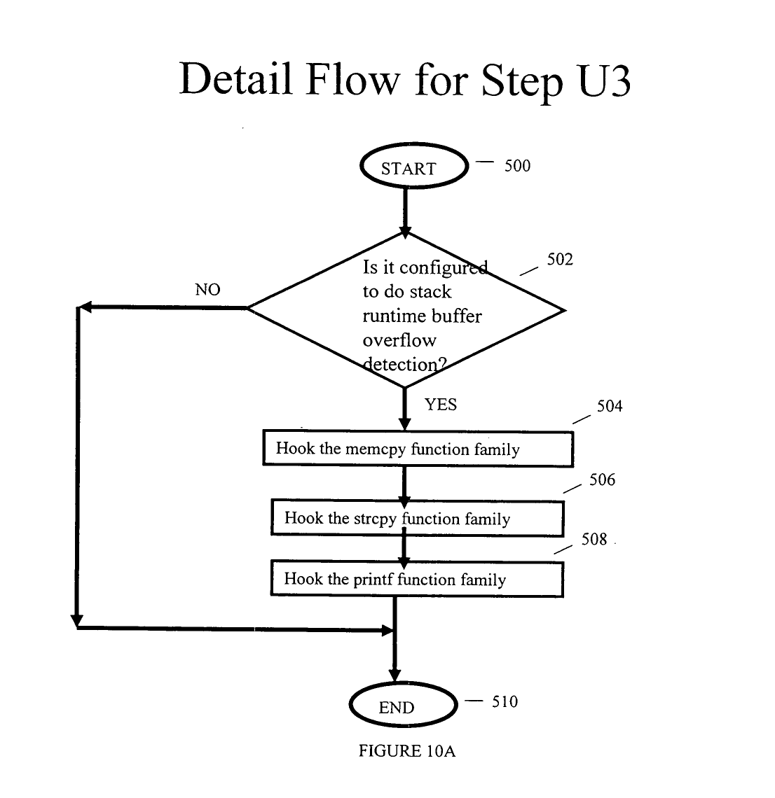

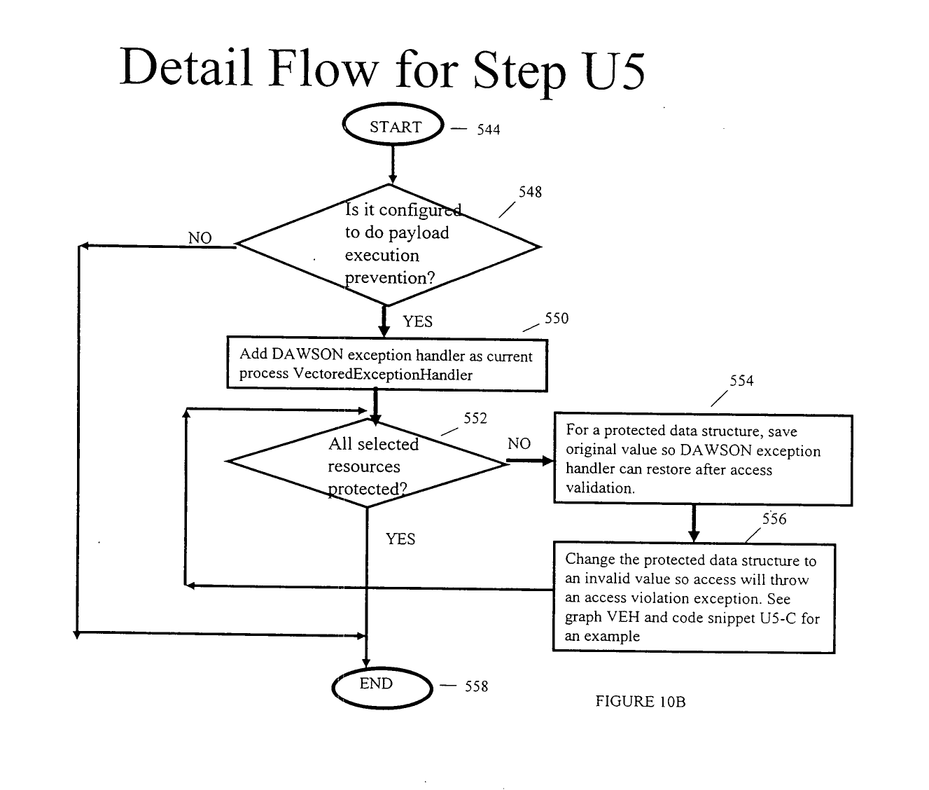

FIG. 10A is a flow diagram showing additional or more detailed exemplary steps of step U3 of FIG. 2B, according to principles of the invention, starting at step 500. At step 502, a check is made whether the system is configured to perform a stack runtime buffer overflow detection. If not, the process ends at step 510. Otherwise, if so configured, at step 504 the memcpy function family is hooked. At step 506, the strcpy function family is hooked. At step 508, the printf function family is hooked. At step 510, the process ends.

FIG. 10B is a flow diagram showing additional exemplary steps of step U5 of FIG. 2B, according to principles of the invention, starting at step 544. At step 548, a check is made whether the system is configured to do payload execution prevention. If not the process ends at step 558. Otherwise if so, then at step 550, DAWSON exception handler is added as current process VectoredExceptionHandler. At step 552, a check is made whether all selected resources are protected. If so the process ends at step 558. Otherwise if not, at step 556, the protected data structure is changed to an invalid value so that an access will throw an access violation exception. See diagram VEH and code snippet U5-C for an example.

Example Code Snippet U5-C

```
    bool ProtectPEBLdrList(void)
    // An example for protecting Loaded Module Lists in PEB structure
    {
      if((void *)g_pebLdr) {
      DWORD ldwOldProtect = 0;
      DWORD lTmp;
      if(VirtualProtect((void *)g_pebLdr,
      sizeof(NT::PEB_LDR_DATA),
    PAGE_READWRITE, &ldwOldProtect ))
      {
            dwCorrectInLoadOrderModuleListFLink=
    (unsignedlong)(((NT::PPEB_LDR_DATA)g_pebLdr)-
      >InLoadOrderModuleList.Flink);
            dwCorrectInLoadOrderModuleListBLink=
    (unsignedlong)(((NT::PPEB_LDR_DATA)g_pebLdr)-
      >InLoadOrderModuleList.Blink);
            dwCorrectInMemoryOrderModuleListFLink=
    (unsignedlong)((NT::PPEB_LDR_DATA)g_pebLdr)-
      >InMemoryOrderModuleList.Flink;
            dwCorrectInMemoryOrderModuleListBLink=
    (unsigned long)((NT::PPEB_LDR_DATA)g_pebLdr)-
      >InMemoryOrderModuleList.Blink;
            dwCorrectInInitializationOrderModuleListFLink=
    (unsigned long)((NT::PPEB_LDR_DATA)g_pebLdr)-
      >InInitializationOrderModuleList.Flink;
            dwCorrectInInitializationOrderModuleListBLink=
    (unsigned long)((NT::PPEB_LDR_DATA)g_pebLdr)-
      >InInitializationOrderModuleList.Blink;
      ((NT::PPEB_LDR_DATA)g_pebLdr)->
InLoadOrderModuleList.Blink=(struct_LIST_ENTRY *)
dwBadInLoadOrderModuleListBLink;
      ((NT::PPEB_LDR_DATA)g_pebLdr)->
InLoadOrderModuleList.Flink=(struct_LIST_ENTRY *)
dwBadInLoadOrderModuleListFLink;
      ((NT::PPEB_LDR_DATA)g_pebLdr)->
InMemoryOrderModuleList.Blink=(struct_LIST_ENTRY *)
dwBadInMemoryOrderModuleListBLink;
      ((NT::PPEB_LDR_DATA)g_pebLdr)->
InMemoryOrderModuleList.Flink=(struct_LIST_ENTRY *)
dwBadInMemoryOrderModuleListFLink;
      ((NT::PPEB_LDR_DATA)g_pebLdr)-
>InInitializationOrderModuleList.Blink=(struct_LIST_ENTRY*)
dwBadInInitializationOrderModuleListBLink;
      ((NT::PPEB_LDR_DATA)g_pebLdr)-
>InInitializationOrderModuleList.Flink = (struct_LIST_ENTRY *)
dwBadInInitializationOrderModuleListFLink;
      VirtualProtect((void *)g_pebLdr, sizeof(NT::PEB_LDR_DATA),
ldwOldProtect, &lTmp );
        return true;
        }
      }
      return false;
```

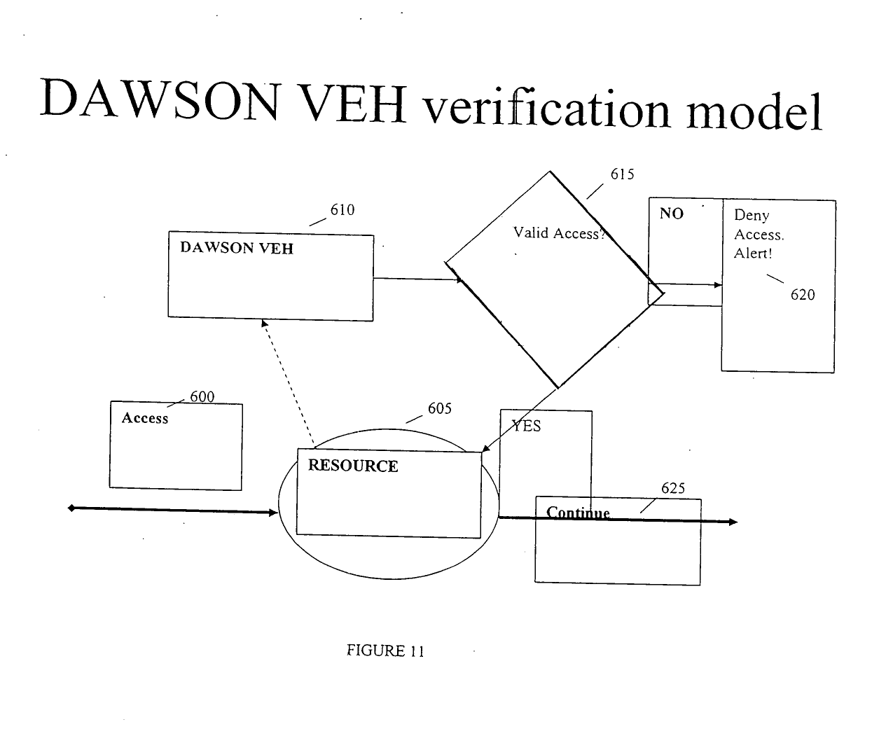

FIG. 11 is a functional flow diagram illustrating the operation of the VEH verification module, according to principles of the invention. An access 600 to a resource 605 is intercepted by the DAWSON VEH 610. A check 615 is made to determine if this is a valid access. If not, at 620 access may be denied and an alert may be generated. If a valid access, normal process continues 625.

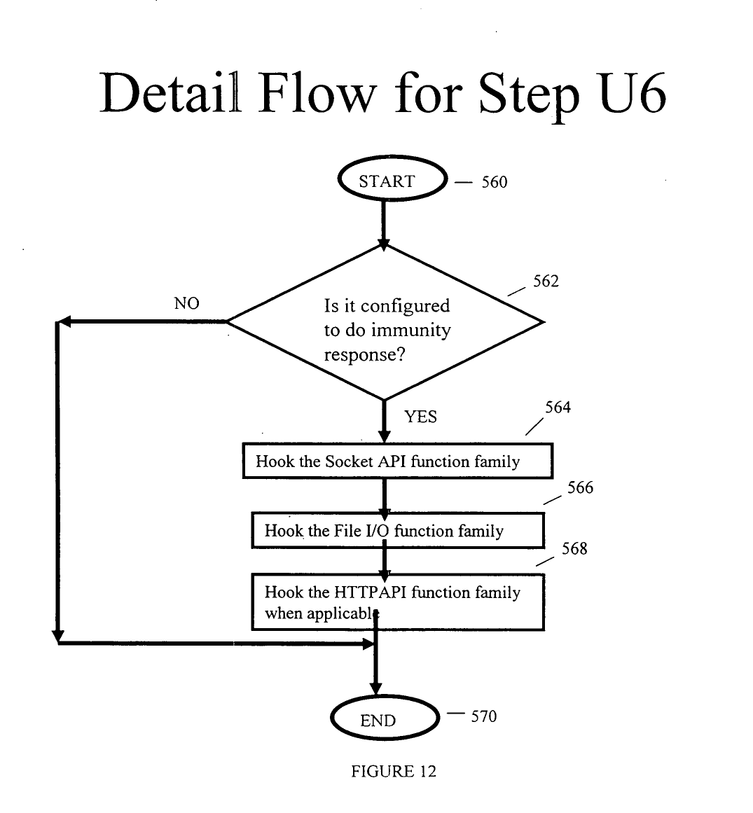

FIG. 12 is a flow diagram showing additional exemplary steps of step U6 of FIG. 2B, according to principles of the invention, starting at step 560. At step 562, a check is made whether the system is configured to do immunity response. If not, the process ends at step 570. Otherwise, at step 564, the socket API function family is hooked. At step 566, the file I/O family is hooked. At step 568, the HTTP API function family, when applicable, is hooked. The process ends at step 570.

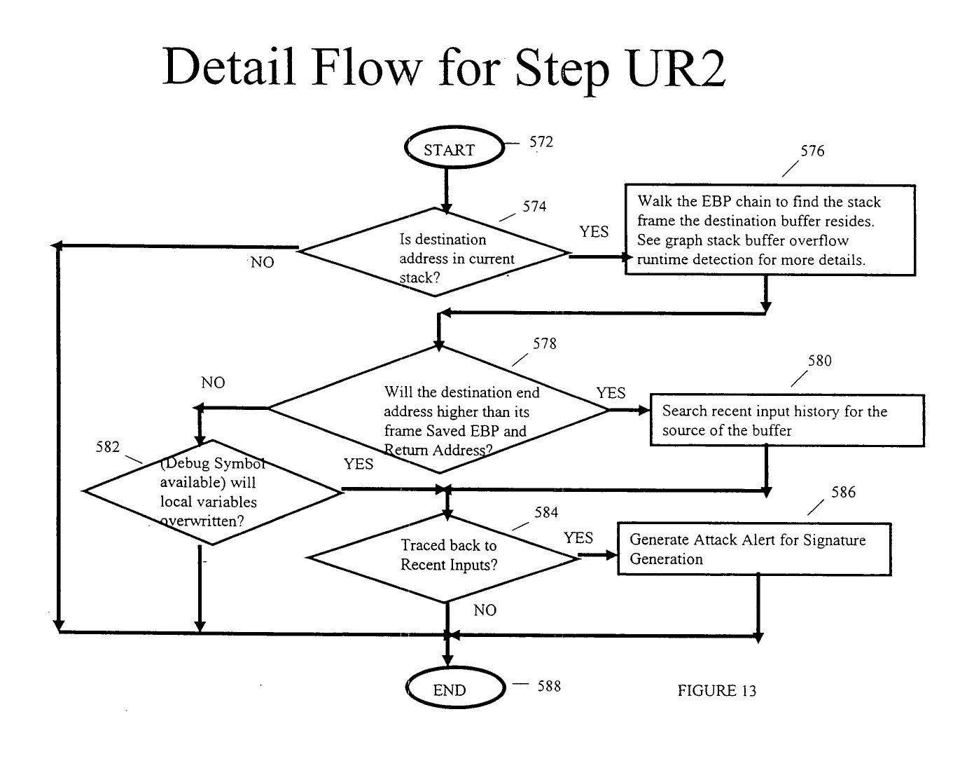

FIG. 13 is a flow diagram showing additional exemplary steps of step UR2 of FIG. 2C, according to principles of the invention, starting at step 572. At step 574, a check is made whether the destination address is in the current stack. If not, the process ends at step 588. Otherwise, at step 576, the EBP chain is “walked” to find the stack frame in which the destination buffer resides. (See illustration of the stack buffer overflow runtime detection for more details). At step 578, a check is made whether the destination end address will be higher than its frame saved EBP and return address. If so, at step 580, the recent input history is searched for the source of the buffer, and processing continues at step 584. Otherwise if not higher, when symbol is available, a check is made to determine if local variables will be overwritten. If not, the process ends at step 588. If the local variable will be overwritten, at step 584, a check is made to see if a trace back to any recent inputs can be determined. If so, at step 586, an attack alert is generated for signature generation. The process ends at step 588.

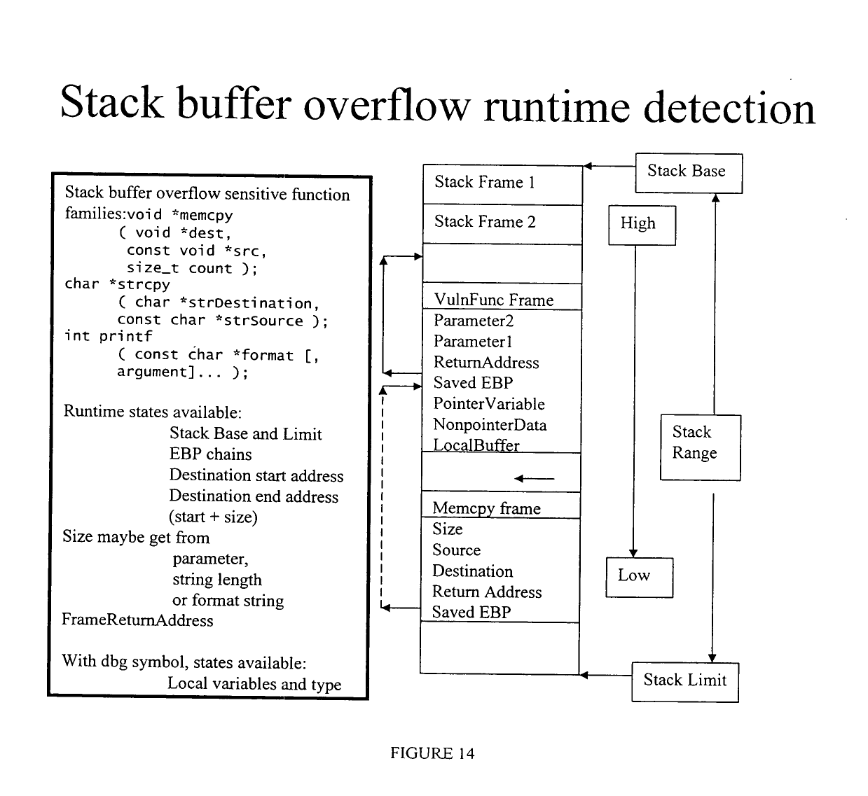

FIG. 14 is an illustration of a stack buffer overflow runtime detection scenario in the context of memcpy call, according to principles of the invention. A memcpy is called from a vulnerable function that doesn't check the size of the src buffer, on the right side of FIG. 14, it shows the stack memory layout when memcpy is invoked by the vulnerable function while the left side box shows the states that are readily available at runtime, for example, the current stack base and limit, the EBP, ESP register values, etc. In the memcpy wrapper setup at step 268, both src and dest are available as parameter, and the size for src is also available as parameter. It is straightforward to check if dest is a buffer on the stack by checking if its address is within current stack base and limit; for the dest buffer on stack, techniques available to locate its stack frame by walking the stack and its corresponding address for the return address in the frame, with symbol help even local variables of the stack frame can be located. With all these information, it is easy to determine if memcpy will overflow the dest buffer (dest+size is the limit) and overwrite the original return address and/or local variables before the real memcpy call is invoked. Strcpy and printf can work in a similar fashion to determine if overflow will happen before actually invoke the overflow action. This is working with the continuous memory overflow, hence not working with a 4-byte target overwrite where continuous memory overwrite is not needed.

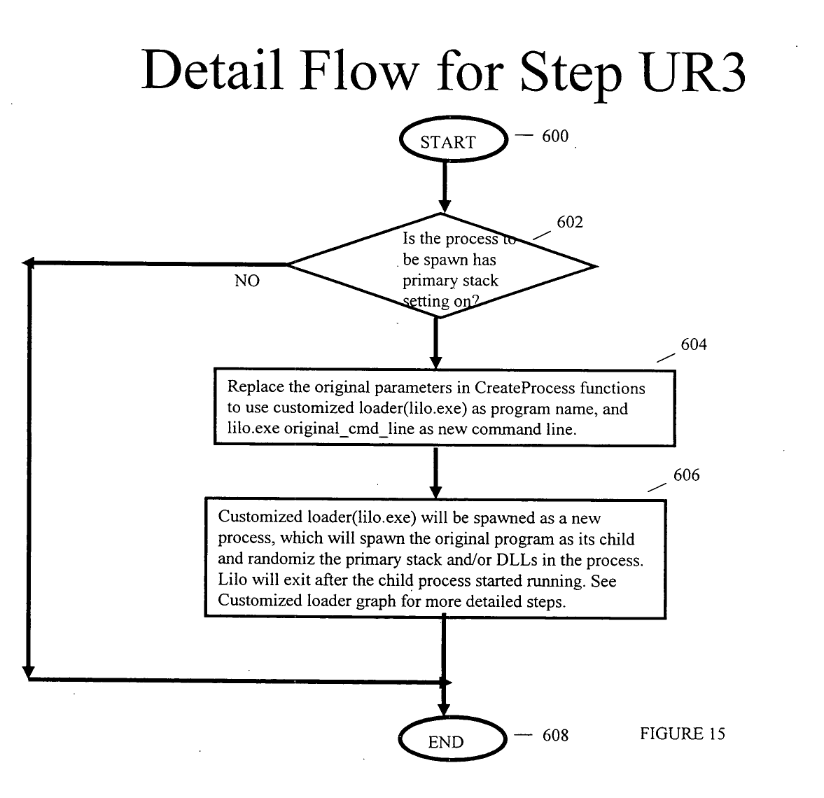

FIG. 15 is a flow diagram showing additional exemplary steps of step UR3 of FIG. 2C, according to principles of the invention, starting at step 600. At step 602, a check is made whether the process to be spawned has primary stack setting on. If not, the process sends at step 608. Else, if on, at step 604, the original parameters in CreateProcess functions is replaced to use customized loader (lilo.exe) as program name, and (lilo.exe original_cmd_line as new command line. At step 606, customized loader(lilo.exe) is spawned as a new process, which spawns the original program as its child and randomizes the primary stack and/or DLLs in the process. Lilo exits after the child process starts running. At step 608, the process ends.

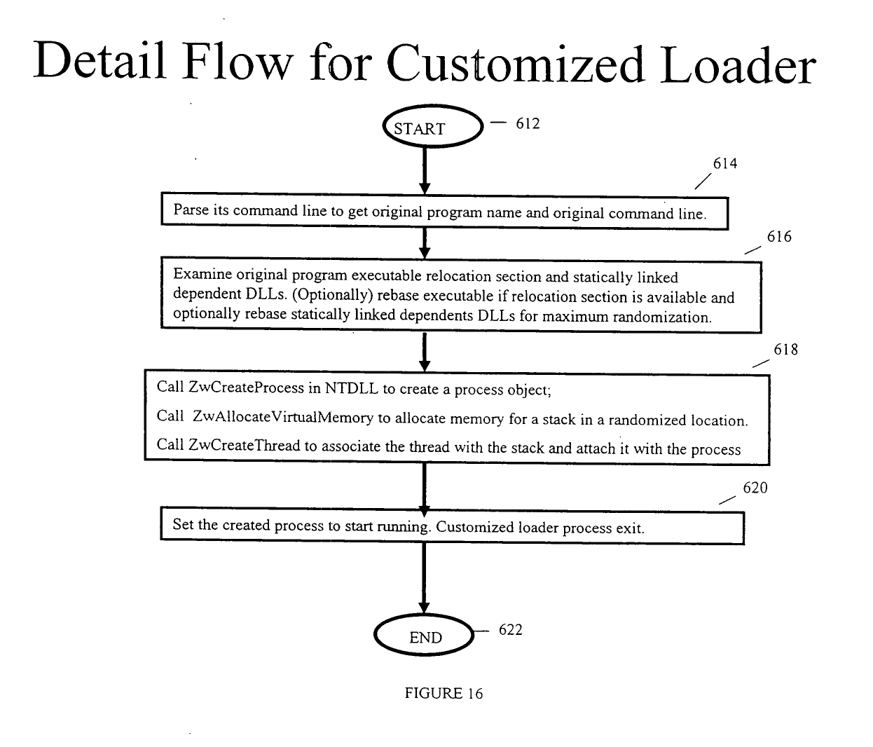

FIG. 16 is a flow diagram showing additional exemplary steps of a customized loader, according to principles of the invention, starting at step 612. At step 614, the command line is parsed to get original program name and original command line. At step 616, the original program executable relocation section and statically linked dependent DLLs are examined; (optionally) rebase executable if relocation section is available and optionally rebase statically linked dependents DLLs for maximum randomization. At step 618, call ZwCreateProcess in NTDLL to create a process object; call ZwAllocateVirtualMemory to allocate memory for a stack in a randomized location and call ZwCreateThread to associate the thread with the stack and attach it with the process. At step 620, the created process is set to start running. At step 622, the process exits.

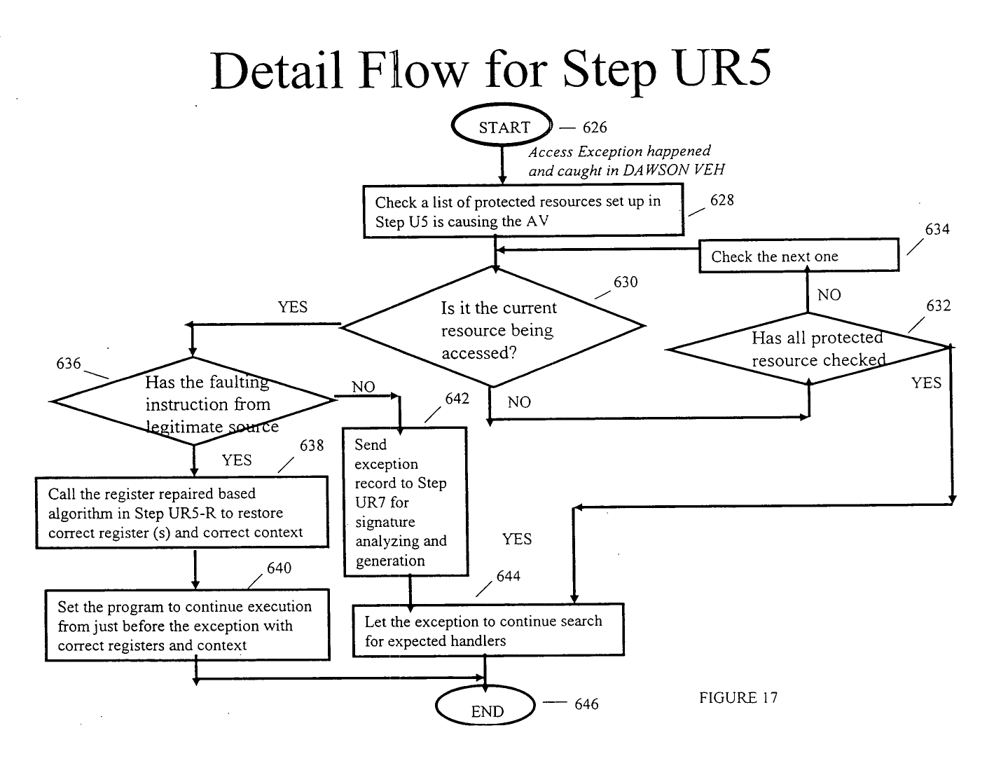

FIG. 17 is a flow diagram showing additional exemplary steps for step UR5 of FIG. 2C, according to principles of the invention, starting at step 626. At step 628, a list of protected resources set up in Step U5 is check to see it is causing the memory access violation.

At step 630 a check is made to see if the current resource is being accessed. If not, at step 63, another check is made to see if all protected resources checked. If so, processing continues at step 644. Otherwise, if not all checked, then processing continues at step 634, where the next resource is readied for checking and processing continues at step 630.

If at step 630, the current resource is being accessed, at step 636, a check is made whether the faulting instruction is form a legitimate source. If not, at step 642, an exception record is sent to step UR7 for signature analysis and generation. At step 644, exception continues searching for expected handlers. The process ends at step 646.

If at step 636, the faulting instruction was not from a legitimate source, at step 638, the register repaired based algorithm is called in Step UR5-R to restore correct register (s) and correct context. At step 640, the program is set to continue execution from just before the exception with correct registers and context. The process ends at step 646.

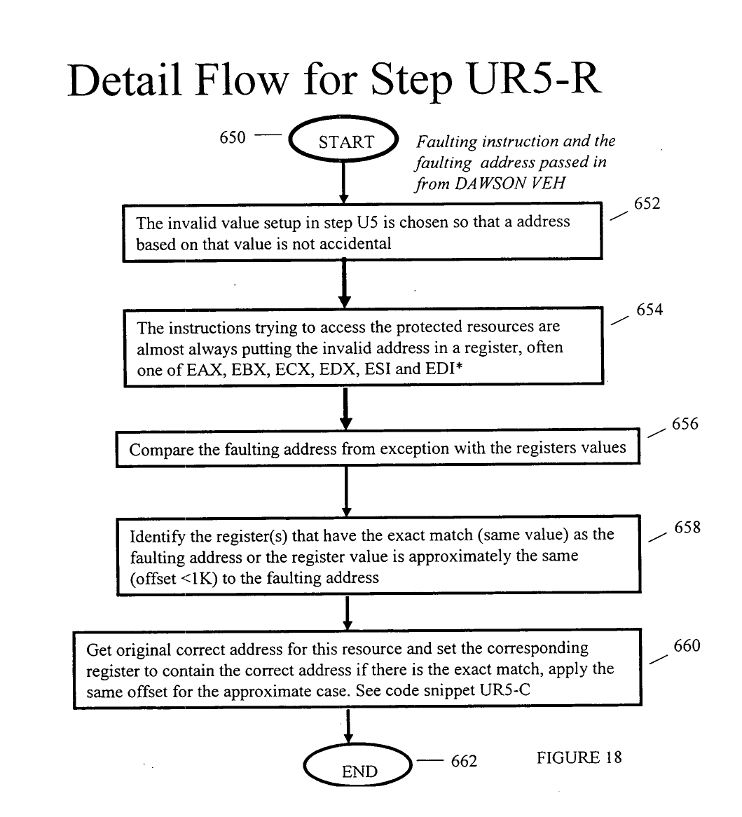

FIG. 18 is a flow diagram showing additional exemplary steps of step UR5-R, according to principles of the invention, starting at step 650. At step 652, the invalid value setup in step U5 is chosen so that an address based on that value is not accidental. At step 654, the instructions trying to access the protected resources are typically putting the invalid address in a register, often one of EAX, EBX, ECX, EDX, ESI and EDI, capture this. At step 656, compare the faulting address from exception with the registers values. At step 658, identify the register(s) that have the exact match (same value) as the faulting address or the register value is approximately the same (offset <1 K) to the faulting address. At step 660, get original correct address for this resource and set the corresponding register to contain the correct address if there is an exact match, apply the same offset for the approximate case. (See code snippet UR5-C, for an example)

CODE Snippet UR5-C

```
//May have multiple registers that are minimum or close to minimum.
Repair them all
bool RepairExceptionRegisterForPEB(PEXCEPTION_POINTERS
pExceptionInfo,unsigned long BadValue,long GoodValue)
{
    long deltaValue[REGNUM];
    deltaValue[EAXREG]=pExceptionInfo->ContextRecord->Eax -
    BadValue;
    deltaValue[EBXREG]=pExceptionInfo->ContextRecord->Ebx -
    BadValue;
    deltaValue[ECXREG]=pExceptionInfo->ContextRecord->Ecx -
    BadValue;
    deltaValue[EDXREG]=pExceptionInfo->ContextRecord->Edx -
    BadValue;
    deltaValue[ESIREG]=pExceptionInfo->ContextRecord->Esi -
    BadValue;
    deltaValue[EDIREG]=pExceptionInfo->ContextRecord->Edi -
    BadValue;
    int iIndex =0;
    unsigned long deltaMIN = abs(deltaValue[EAXREG]);
    for(int i =1; i<REGNUM;i++)
    {
        if(deltaMIN >abs(deltaValue[i]))
        {
            deltaMIN = abs(deltaValue[i]);
            iIndex = i;
        }
    }
for(i =0;i<REGNUM;i++) {
        if(deltaMIN <= abs(deltaValue[i]) && abs(deltaValue[i])
<=deltaMIN+ 0x100) {
            if(i==EAXREG)
                pExceptionInfo->ContextRecord->Eax =
GoodValue+deltaValue[i];
            else if(i==EBXREG)
                pExceptionInfo->ContextRecord->Ebx =
GoodValue+deltaValue[i];
            else if(i==ECXREG)
                pExceptionInfo->ContextRecord->Ecx =
GoodValue+deltaValue[i];
            else if(i==EDXREG)
                pExceptionInfo->ContextRecord->Edx =
GoodValue+deltaValue[i];
            else if(i==ESIREG)
                pExceptionInfo->ContextRecord->Esi =
GoodValue+deltaValue[i];
            else if(i==EDIREG)
                pExceptionInfo->ContextRecord->Edi =
GoodValue+deltaValue[i];
        }
    }
    return true;
}
```

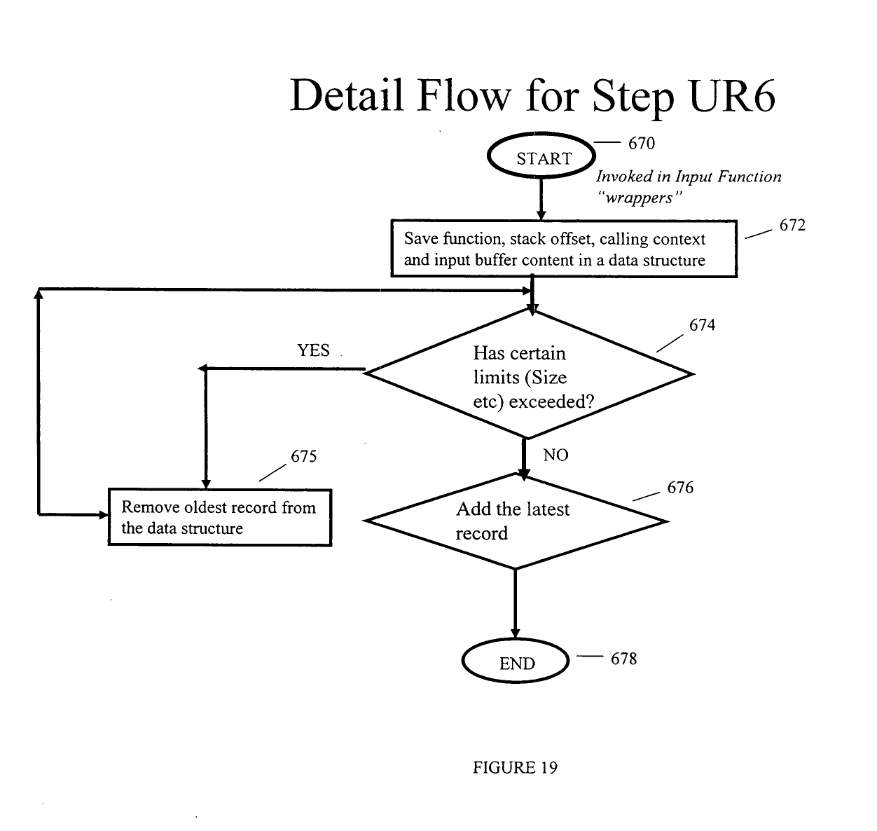

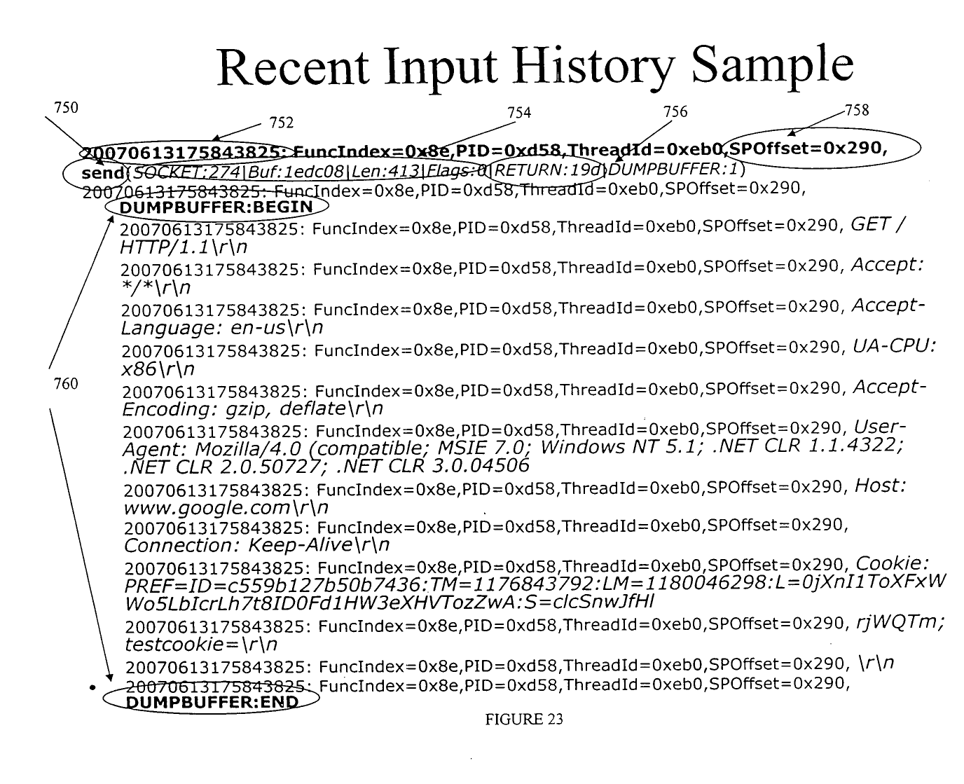

FIG. 19 is a flow diagram showing additional exemplary steps of step UR6 of FIG. 2C, according to principles of the invention, starting at step 670. At step 672, save function, stack offset, calling context and input buffer content in a data structure. (FIG. 23 is an illustrative example of what information is typically saved in such a data structure, discussed more below). At step 674, a check is made to see if certain size limits (pre-determined) have been exceed. If yes, at step 675, the oldest record is removed from the data structure. Process continues at step 674. Otherwise, if at step 674, the size has not been exceeded, at step 676, the latest record is added. The process ends at step 678.

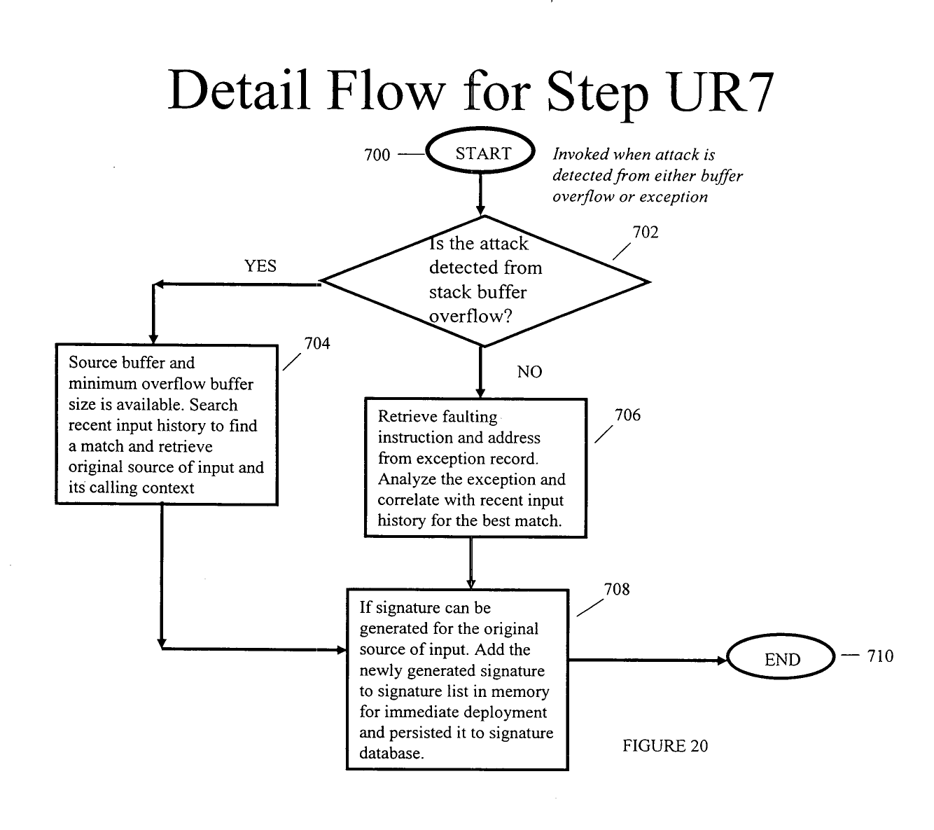

FIG. 20 is a flow diagram showing additional exemplary steps of step UR7 of FIG. 2C, according to principles of the invention, starting at step 700. At step 702, a check is made if the attack is detected from a stack buffer overflow. If yes, at step 704, since the source buffer and minimum overflow buffer size is available, a search of recent input history to find a match is made, and retrieval of original source of input and its calling context is performed. At step 708, if a signature can be generated for the original source of input, add the newly generated signature to signature list in memory for immediate deployment and persist it to signature database. At step 710 the process ends.

If, however, at step 702, the attack is not detected from the stack buffer overflow, retrieve faulting instruction and address from exception record; analyze the exception and correlate with recent input history for the best match. Processing continues at step 708, described above.

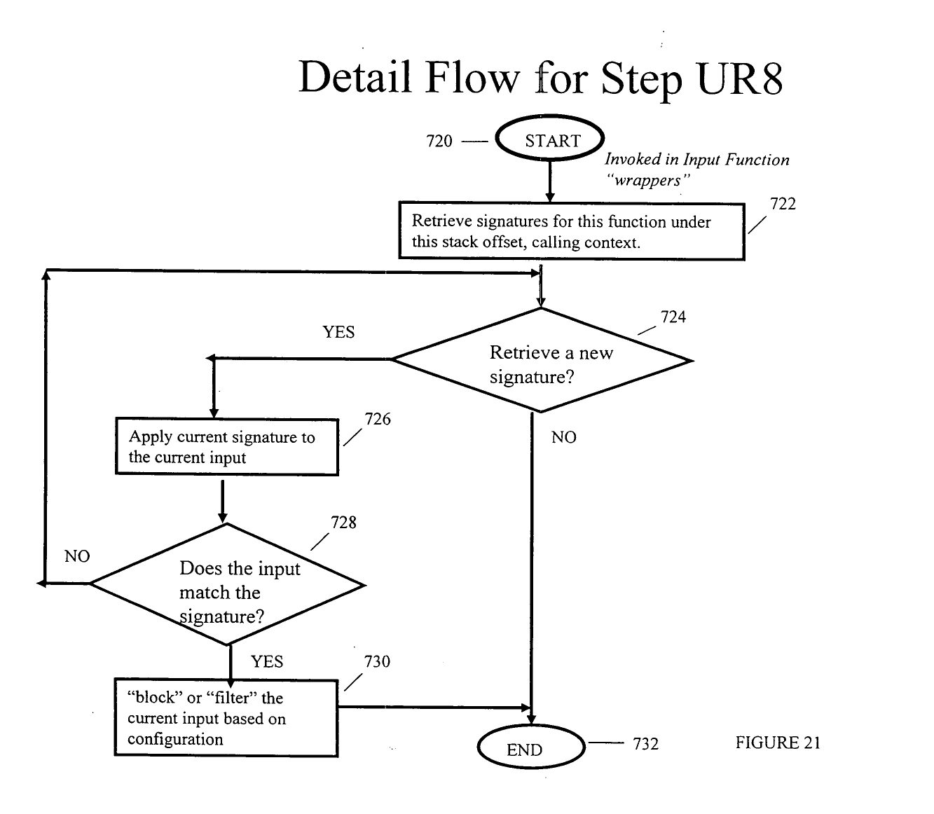

FIG. 21 is a flow diagram showing additional exemplary steps of step UR8 of FIG. 2C, according to principles of the invention, starting at step 720. At step 722, retrieve signatures for this function under this stack offset, calling context. At step 724, a check is made whether to retrieve anew signature. If not then the process ends at step 732. However, if a new signature is to be retrieved, at step 726, the current signature is applied to the current input. At step 728, a check is made whether the input matches the signature. If not, the processing continues at step 724. If the input does match the signature, at step 730, a “block” or “filter” is applied to the current input based on configuration. At step 732 the process ends.

FIG. 23 is an illustrating example showing what a typical recent input history record collected and maintained by function interceptor in Step UR6 (see, FIG. 19) looks like, according to principles of the invention. This particular sample shows information collected related to a function call, including 750 function name, 752 timestamp, 754 parameter name and value pair list, 756 return code, 758 calling context uniquely identified by the offset from the stack base and 760 the printable buffer content in ASCII code.

### Dynamically Linked Libraries

For perspective, UNIX operating systems generally rely on shared libraries, which contain position-independent code. This refers to that they can be loaded anywhere in virtual memory, and no relocation of the code would ever be needed. This has an important advantage: different processes may map the same shared library at different virtual addresses, yet be able to share the same physical memory.

In contrast, Windows® DLLs contain absolute references to addresses within themselves, and hence are not position-independent. Specifically, if the DLL is to be loaded at a different address from its default location, then it has to be explicitly “rebased,” which involves updating absolute memory references within the DLL to correspond to the new base address.

Since rebasing modifies the code in a DLL, there is no way to share the same physical memory on Windows® if two applications load the same DLL at different addresses. As a result, the common technique used in UNIX for library randomization, i.e., mapping each library to a random address as it is loaded, would be very expensive on Windows® since Windows® would require a unique copy of each library for every process. To avoid this, DAWSON rebases a library the first time it is loaded after a reboot. All processes will then share this same copy of the library. This default behavior for a DLL can be changed by explicit configuration, using a Windows® Registry entry.

In terms of the actual implementation, rebasing is done by hooking the NtMapViewOfSection function provided by ntdll, and modifying a parameter that specifies the base address of the library.

The above approach does not work for certain libraries such as ntdll and kernel32 that get loaded very early during the reboot process. However, kernel-mode drivers to rebase such DLLs have been provided. Specifically, an offline process is provided to create a (randomly) rebased version of these libraries before a reboot. Then, during the reboot, a custom boot-driver is loaded before the Win32 subsystem is started up, and overwrites the disk image of these libraries with the corresponding rebased versions. When the Win32 subsystem starts up, these libraries are now loaded at random addresses.

When the base of a DLL is randomized, the base address of code, as well as static data within the DLL, gets randomized. The granularity of randomization that can be achieved is somewhat coarse, since Windows® requires DLLs to be aligned on a 64 K boundary, thus removing 16-bits of randomness. In addition, since the usable memory space on Windows® is typically 2 GB, this takes away an additional bit of randomness, thus leaving 15-bits of randomness in the final address.

### Stack Randomization

Unlike UNIX, where multithreaded servers aren't the norm, most servers on Windows® are multi-threaded. Moreover, most request processing is done by child threads, and hence it is more important to protect the thread stacks. According to the invention, randomizing thread stacks is based on hooking the CreateRemoteThread call, which in turn is called by CreateThread call, to create a new thread. This routine takes the address of a start routine as a parameter, i.e., execution of the new thread begins with this routine. This parameter may be replaced with the address of a “wrapper” function of the invention. This wrapper function first allocates a new thread stack at a randomized address by hooking NtAllocateVirtualMemory. However, this isn't usually sufficient, since the allocated memory has to be aligned on a 4 K boundary. Taking into account the fact that only the lower 2 GB of address space is typically usable, this leaves only 19-bits of randomness. To increase the randomness range, the wrapper function routine decrements the stack by a random number between 0 and 4 K that is a multiple of 4. (Stack should be aligned on a 4-byte boundary.) This provides additional 10-bits of randomness, for a total of 29 bits.

The above approach does not work for randomizing the main thread that begins execution when a new process is created. This is because the CreateThread isn't involved in the creation of this thread. To overcome this problem, we have written a “wrapper” program to start an application that is to be diversified. This wrapper is essentially a customized loader. It uses the low-level call NtCreateProcess to create a new process with no associated threads. Then the loader explicitly creates a thread to start executing in the new process, using a mechanism similar to the above for randomizing the thread stack. The only difference is that this requires the use of a lower-level function NtCreateThread rather than CreateThread or CreateRemoteThread.

### Executable Base Address Randomization

In order to “rebase” the executable, we need the executable to contain relocation information. This information, which is normally included in DLLs and allows them to be rebased, is not typically present in COTS binaries, but is often present in debug version of applications. When relocation information is present, rebasing of executables involved is similar to that of DLLs: an executable is rebased just before it is executed for the first time since a reboot, and future executions can share this same rebased version. The degree of randomness in the address of executables is the same as that of DLLs.

If relocation information is not present, then the executable cannot be rebased. While randomization of other memory regions protects against most known types of exploits, an attacker can craft specialized attacks that exploit the predictability of the addresses in the executable code and data. We describe such attacks in Section 4 and conclude that for full protection, executable base randomization is essential.

### Heap Randomization

Windows® applications typically use many heaps. A heap is created using an RtlCreateHeap function. This function (i.e., RtlCreateHeap) is hooked so as to modify the base address of the new heap. Once again, due to alignment requirements, this rebasing can introduce randomness of only about 19 bits. To increase randomness further, individual requests for allocating memory blocks from this heap are also hooked, specifically, RtlAllocateHeap, RtlReAllocate, and RtlFreeHeap. Heap allocation requests are increased by either 8 or 16 bytes, which provides another bit of randomness for a total of 20 bits.

The above approach is not applicable for rebasing the main heap, since the address of the main heap is determined before the randomization DLL is loaded. For the main heap, when it is created, the randomization DLL has NOT been loaded and therefore is not able to intercept the function calls. Specifically, the main heap is created using a call to RtlCreateHeap within the LdrpInitializeProcess function. The kernel driver patches this call and transfers control to a wrapper function. This wrapper function modifies a parameter to the RtlCreateHeap so that the main heap is rebased at a random address aligned on a 4 K page boundary. For normal heaps, when they are created, the randomization DLL has been loaded and the hook to intercept related functions has been setup at the randomization DLL loading time

In addition, a 32-bit “magic number” is added to the headers used in heap blocks to provide additional protection against heap overflow attacks. Heap overflow attacks operate by overwriting control data used by heap management routines. This data resides next to the user data stored in a heap-allocated buffer, and hence could be overwritten using a buffer overflow vulnerability. By embedding a random 32-bit quantity that will be checked before any block is freed, the success probability is reduced of most heap overflow attacks to a negligible number.

### Randomization of Other Sections

### PEB and TEB

PEB and TEB are created in kernel mode, specifically, in the MiCreatePebOrTeb function ofntoskrnl.exe. The function itself is a complicated function, but the algorithm for PEB/TEB location is simple: it searches the first available address space from an address specified in a variable MmHighestUserAddress. The value of this variable is always 0x7ffeffff for XP platforms, and hence PEB and TEB are at predictable addresses normally. IN Windows® XP SP2, the location of PEB/TEB is randomized a bit, but it only allows for 16 different possibilities, which is too small to protect against brute force attacks.

DAWSON patches the memory image of ntoskrnel.exe in the boot driver so that it uses the contents of another variable RandomizedUserAddress, a new variable initialized by the boot driver. By initializing this variable with different values, PEB and TEB can be located on any 4 K boundary within the first 2 GB of memory, thus introducing 19-bits of randomness in its location.

### Environment Variables and Command-Line Arguments

In Windows, environment variables and process parameters reside in separate memory areas. They are accessed using a pointer stored in the PEB. To relocate them, the invention allocates randomly-located memory and copies over the contents of the original environment block and process parameters to the new location. Following this, the original regions are marked as inaccessible, and the PEB field is updated to point to the new locations.

### VAD Regions

There are two types of VAD regions. The first type is normally at the top of user address space (on SP2 it is 0x7ffe1111-0x7ffef000). These pages are updated from kernel and read by user code, thus providing processes with a faster way to obtain information that would otherwise be obtained using system calls. These types of pages are created in the kernel mode and are marked read-only, and hence we don't randomize their locations. A second type of VAD region represents actual virtual memory allocated to a process using VirtualAlloc. For these regions, we wrap the VirtualAlloc function and modify its parameter IpAddress to a random multiple of 64 K.

### Attack Classes Targeted by DAWSON

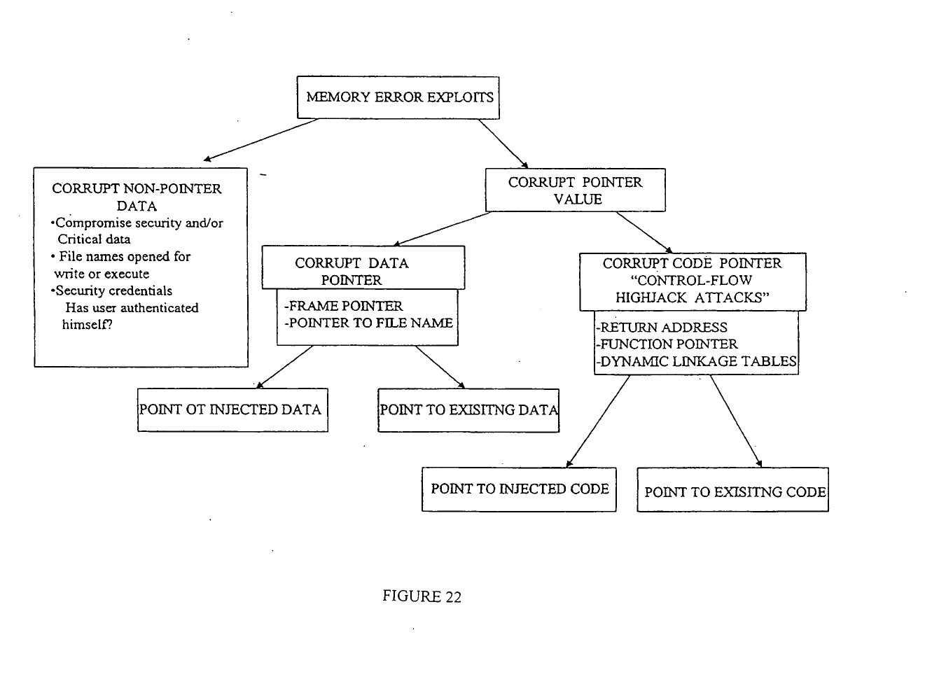

Address space randomization (ASR) defends against exploits of memory errors. A memory error can be broadly defined as that of a pointer expression accessing an object unintended by the programmer. There are two kinds of memory errors: spatial errors, such as out-of-bounds access or dereferencing of a corrupted pointer, and temporal errors, such as those due to dereferencing dangling pointers. It is unclear how temporal errors could be exploited in attacks, so spatial errors are addressed. FIG. 22 is a relational block diagram shows the space of exploits that are based on spatial errors.

Address space randomization does not prevent memory errors, but makes their effects unpredictable. Specifically, “absolute address randomization” provided by DAWSON makes pointer values unpredictable, thereby defeating pointer corruption attacks with a high probability. However, if an attack doesn't target any pointer, then the attack might succeed. Thus, DAWSON can effectively address 4 of the 5 attack categories shown in FIG. 2. The five attack categories include:

Category 1: Corrupt non-pointer data.

Category 2: Corrupt a data pointer value so that it points to data injected by the attacker.

Category 3: Corrupt a pointer value so that it points to existing data chosen by the attacker.

Category 4: Corrupt a pointer value so that it points to code injected by the attacker.

Category 5: Corrupt a pointer value so that it points to existing code chosen by the attacker.

The classes of attacks that specifically target the weaknesses of address space randomization are discussed below.
1. Relative address attacks: DAWSON uses absolute address randomization, but the relative distances between objects within the same memory area are left unchanged. This makes the following classes of attacks possible:
   Data value corruption attacks: Data value corruption attacks that do not involve pointer corruption (and hence don't depend on knowledge of absolute addresses). Two examples of such attacks are:
      a buffer overflow attack that overwrites security-critical data that is next to the vulnerable buffer.
      an integer overflow attack that overwrites a data item in the same memory region as the vulnerable buffer.
   Partial overflow attacks: Partial overflow attacks selectively corrupt the least significant byte(s) of a pointer value. They are possible on little-endian architectures (little-endian means that the low-order byte of the number is stored in memory at the lowest address) that allow unaligned word accesses, e.g., the x86 architecture. Partial overflows can defeat randomization techniques that are constrained by alignment requirements, e.g., if a DLL is required to be aligned on a 64 K boundary, then randomization can't change the least significant 2-bytes of the address of any routine in the DLL. As a result, any attack that can succeed without changing the most-significant bytes of this pointer can succeed in spite of randomization.
   Partial overflows cannot be based on the most common type of buffer overflows associated with copying of strings. This is because the terminating null character will corrupt the higher order bytes of the target. It thus requires one of the following types of vulnerabilities:
      off-by-one (or off-by-N) errors, where a bounds-check (or strncpy) is used, but the bound value is incorrect.
      an integer overflow error that allows corruption of bytes within a pointer located in the same memory region as the vulnerable buffer.
2. Information leakage attacks: If there is a vulnerability in the victim program that allows an attacker to get (or use) the values of some pointers in its memory, the attacker can compare the value of these pointers with those in an unrandomized version of the program, and infer the value of the random number(s) used. A particular type of example in this category is a format-string attack that uses the % n directive, but rather than providing the address where the data is to be written, simply uses some address that happens to be on the stack. Such an attack eliminates the need to guess the location of the target to be corrupted, but if the target is itself a pointer, one will need to guess the correct value to use. However, if the target is non-pointer data, then this attack can defeat randomization.
3. Brute-force attacks: These attacks attempt to guess the random value(s) used in the randomization process. By trying different guesses, the attacker can eventually break through.
4. Double-pointer attacks: These attacks require the attacker to guess some writable address in process memory. Then the attacker uses one memory error exploit to deposit code at the address guessed by the attacker. A second exploit is used to corrupt a code pointer with this address. Since it is easier to guess some writable address, as opposed to, guessing the address of a specific data object, this attack can succeed more easily than the brute-force attacks.
   Of the four attack types mentioned above, the first two require specific types of vulnerabilities that may not be easy to find and there aren't any reported vulnerabilities that fall into these two classes. If they are found, then ASR won't provide any protection against them. In contrast, it provides probabilistic protection against the last two attack types (i.e., brute force and double-pointer attacks).

### Analytical Evaluation of Effectiveness

In this section, an estimate is presented in Tables 2 and 3 of the work factor involved in defeating DAWSON on the attack classes targeted by it.

TABLE 2
Expected attempts needed across
possible attack types.

Attack target

| Attack type | Stack/Heap | Static data/code |
|---|---|---|
| Injected code | 262K* | 16.4K |
| Existing | N/A | 16.4K |
| code | | |
| Injected data | 262K* | 16.4K |
| Existing data | >134 M | 16.4K |

TABLE 3
Expected attempts
needed for common attack types.

| Attack type | # of attempts |
|---|---|
| Stack- | 16.4K-262K |
| smashing | |
| Return-to-libc | 16.4K |
| Heap overflow | 16.4K-268 M |
| Format-string | 16.4K-268 M |
| Integer | 16.4K-268 M |
| overflow | |

### Probability of Successful Brute-Force Attacks

Table 2 summarizes the expected number of attempts required for different attack types. Note that the expected number of attacks is given by 2/p, where p is the success probability for an attack. The numbers marked with an asterisk depend on the size of the attack buffer, and a number of 4 K bytes have been assumed to compute the figures in the table. Table 3 summarizes the expected attempts needed for common attack types.

Note that an increase in number of attack attempts translates to a proportionate increase in the total amount of network traffic to be sent to a victim host before expecting to succeed. For instance, the expected amount of data to be sent for injected code attacks on stack is 262 K*4 K, or about 1 GB. For injected code attacks involving buffers in the static area, assuming a minimum size of 128 bytes for each attack request, is 16.4 K*128=2.1 MB.

Injected code attacks: For such attacks, note that the attacker has to first send malicious data that gets stored in a victim program's buffer, and then overwrite a code pointer with the absolute memory location of this buffer. DAWSON provides no protection against the overwrite step: if a suitable vulnerability is found, the attacker can overwrite the code pointer. However, it is necessary for the attacker to guess the memory location of the buffer. The probability of a correct guess can be estimated from the randomness in the base address of different memory regions:
Stack: Table 1 shows that there is 29 bits of randomness on stack addresses, thus yielding a probability of ½²⁹. To increase the odds of success, the attacker can prepend a long sequence of NOPs to the attack code. A NOP-padding of size 2ⁿ would enable a successful attack as long as the guessed address falls anywhere within the padding. Since there are 2ⁿ⁻² possible 4-byte aligned addresses within a padding of length 2-bytes, the success probability becomes ½³¹⁻ⁿ.
Heap: Table 1 also shows that there is 20 bits of randomness. Specifically, bits 3 and bits 13-31 have random values. Since a NOP padding of 4 K bytes will only affect bits 1 through 12 of addresses, bits 13-31 will continue to be random. As a result, the probability of successful attack remains ½¹⁹ for a 4 K padding. It can be shown that for larger NOP padding of 2ⁿ bytes, the probability of successful attack remains ½³¹⁻ⁿ.
Static data: According to Table 1, there are 15-bits of randomness in static data addresses: specifically, the MSbit and the 16 LSbits aren't random. Since the use of NOP padding can only address randomness in the lower order bits of address that are already predictable, the probability of successful attacks remains ½¹⁵. (This assumes that the NOP padding cannot be larger than 64 K.)
   Existing code attacks: An existing code attack may target code in DLLs or in the executable. In either case, Table 1 shows that there are 15-bits of randomness in these addresses. Thus, the probability of correctly guessing the address of the code to be exploited is ½¹⁵.

Existing code attacks are particularly lethal on Windows® since they allow execution of injected code. In particular, instructions of the form jmp [ESP] or call [ES P] are common in Windows® DLLs and executables. A stack-smashing attack can be crafted so that the attack code occurs at the address next to (i.e., higher than) the location of the return address corrupted by the attack. On a return, the code will execute a jmp [ESP]. Note that ES P now points to the address where the attack code begins, thus allowing execution of attack code without having to defeat randomization in the base address of the stack.

Note that exploitable code sequences may occur at multiple locations within a DLL or executable. One might assume that this factor will correspondingly multiply the probability of successful attacks. However, note that the randomness in code addresses arise from all but the MSbit and the 16 LSbits. It is quite likely that different exploitable code sequences will differ in the 16 LSbits, which means that exploiting each one of them will require a different attack attempt. Thus, the probability of ½¹⁵ will still hold, unless the number of exploitable code addresses is very large (say, tens of thousands).

Injected Data Attacks involving pointer corruption: Note that the probability calculations made above were dependent solely on the target region of a corrupted pointer: whether it was the stack, heap, static data, or code. In the case of data attacks, the target is always a data segment, which is also the target region for injected code attacks. Note that the NOP padding isn't directly applicable to data attacks, but the higher level idea of replicating an attack pattern (so as to account for uncertainty in the exact location of target data) is still applicable. By repeating the attack data 2′ times, the attacker can increase the odds of success to 2ⁿ⁻³¹ for data on the stack or heap, and 2⁻¹⁵ for static data.
Existing Data Attacks involving pointer corruption: The main difference between injected data and existing data attacks is that the approach of repeating the attack data isn't useful here. Thus, the probability of a successful attack on the stack is 2⁻²⁹, on the heap is 2⁻²⁰ and on static data is 2⁻¹⁵.

### Success Probability of Double-Pointer Attacks

Double-pointer attacks work as follows. In the first step, an attacker picks a random memory address A, and writes attack code at this address. This step utilizes an absolute address vulnerability, such as a heap overflow or format string attack, which allows the attacker to write into memory location A. In the second step, the attacker uses a relative address vulnerability such as a buffer overflow to corrupt a code pointer with the value of A. (The second step will not use an absolute address vulnerability because the attacker would then need to guess the location of the pointer to be corrupted in the second step.)

From an attacker's perspective, a double-pointer attack has the drawback that it requires two distinct vulnerabilities: an absolute address vulnerability and a relative address vulnerability. Its benefit is that the attacker need only guess a writable memory location, which requires far fewer attempts. For instance, if a program uses 200 MB of data (10% of the roughly 2 GB virtual memory available), then the likelihood of a correct guess for A is 0.1. For processes that use much smaller amount of data, say, 10 MB, the success probability falls to 0.005.

### Success Probabilities for Known Attacks

In this section, we consider specific attack types that have been reported in the past, and analyze the number of attempts needed to be successful. We consider modifications to the attack that are designed to make them succeed more easily, but do not consider those variations described in Section 3.2 against which DAWSON isn't effective.

Table 3 summarizes the results of this section. Wherever a range is provided, the lower number is usually applicable whenever the attack data is stored in static variable, and the higher number is applicable when it is stored on the stack.
Stack-smashing: Traditional stack-smashing attacks overwrite a return address, and point it to a location on the stack. From the results in the preceding section, it can be seen that the number of attempts needed will be 262 K, provided that the attack buffer is 4 K.
Return-to-libc: These attacks require guessing the location of some function in kernel32 or ntdll, which requires an expected 16.4 K attempts.
Heap overflow: Due to the use of magic numbers, the common form of heap overflow, which is triggered at the time a corrupted heap block is freed, requires of the order of 2³² attempts. Other types of heap overflows, which corrupt a free block adjacent to another vulnerable heap buffer, remain possible, but such vulnerabilities are usually harder to find. Even if they are found, heap overflows pose a challenge in that they require an attacker to guess the location of two objects in memory: the first is the location of a function pointer to be corrupted, and the second is the location where the attacker's code is stored in memory. The success probability will be highest if (a) the both locations belong to the same memory region, and (b) this memory region happens to be the static area. In such a case, the number of attack attempts required for success can be as low as 16 K. However, attacker data is typically not stored in static buffers. In such a case, the attacker would have to guess the location of a specific function pointer on the stack or heap, which may require of the order of 2²⁹/2=268M attempts.
Format-string attacks: Format-string attack involves the use of % n format primitive to write data into victim process memory. Typically, the return address is overwritten, but due to the nature of % n format directive, the attacker needs to guess the absolute location of this return address. This requires of the order of 2²⁹/2=268M attempts. However, the attacker can modify the attack so that some non-pointer in a static area is corrupted. If such vulnerable data can be found, then the attack will succeed with 16.4 K attempts.
Integer overflows: Integer overflows can be thought of as buffer overflows on steroids: they can typically be used to selectively corrupt any data in the process memory using the relative distance between a vulnerable buffer and the target data. They can be divided into the following types for the purpose of our analysis:
   Case (a): Corrupt non-pointer data within the same region. This attack uses the relative distance between a vulnerable buffer and the object to be corrupted, which must exist in the same memory region, e.g., the same stack, heap or static area. Such attacks aren't affected by DAWSON. Note that the term “same” is significant here, since it is typical for Windows® applications to be multithreaded (and hence use multiple stacks), make use of multiple heaps, and contain many DLLs, each of which has its own static data. If the vulnerable buffer and the target are on different stacks (or heaps or DLLs), then case (b) will apply. (Since such non-pointer attacks are outside the scope of DAWSON, this case is not shown in Table 4.)
   Case (b): Corrupt non-pointer data across different memory regions. In this case, the attacker needs to guess the distance between the memory region containing the vulnerable buffer and the memory region containing the target data. Given the randomness figures shown in Table 1, we can estimate the expected number of attempts as follows. If either the vulnerable buffer or the target resides on the stack, then the randomness is the distance between the buffer and the target is of the order of 2²⁹, which translates to an expected number of 268M attempts. If the vulnerable buffer as well as the target reside in static areas, then the expected number of attempts will be about 16.4 K.
   Case (c): Corrupt pointer data. If the value used to corrupt the pointer corresponds to the stack, then the expected number of attacks would be 268M, as before. If the vulnerable buffer or the target resides in different memory regions, and one of them is the stack, once again the number of attack attempts would be at least 268M. If both the vulnerable buffer and the target are in two different static areas, and the corrupting value corresponds to one of these areas, then the number of attempts needed would still be high, since the attacker would need to guess the distance between the two static areas, as well as the base address of one of these areas, the number can be as high as 16 K²=268M. However, if the vulnerable buffer and the target are in the same static area, and the value used in corruption corresponds to a location within the same area, then the number of required attempts can be as low as 16 K.

### Defending Against Brute-Force Attacks

DAWSON provides a minimum of 15-bits of randomness in the locations of objects, which translates to a minimum of 16 K for the expected number of attempts for a successful brute-force attack. This number is large enough to protect against brute-force attacks in practice.

Although brute-force attacks can hypothetically succeed in a matter of minutes even when 16-bits of the address are randomized, this is based on the assumption that the victim server won't mount any meaningful response in spite of tens of thousands of attack attempts. However, a number of response actions are possible, such as (a) filtering out all traffic from the attacker, (b) slowing down the rate at which requests are processed from the attacker, (c) using an anomaly detection system to filter out suspicious traffic during times of attacks, and (d) shutting down the server if all else fails. While these actions risk dropping some legitimate requests, or the loss of a service, it is an acceptable risk, since the alternative (of being compromised) isn't usually an option.

Promising defense against brute-force attacks include filtering out repeated attacks so that brute-force attacks can simply not be mounted. Specifically, these techniques automatically synthesize attack-blocking signatures, and use these signatures to filter out future attacks. Signatures can be developed that are based on the underlying vulnerability, namely, some input field being too long. Thus, it can protect against brute-force attacks that vary some parts of the attack (such as the value being used to corrupt a pointer).

Finally, even if all these fail, DAWSON slows down attacks considerably, requiring attackers to make tens of thousands of attempts, and generating tens of thousands of times increased traffic before they can succeed. These factors can slow down attacks, making them take minutes rather than milliseconds before they succeed. This slowdown also has the potential to slow down very-fast spreading worms to the point where they can be thwarted by today's worm defenses.

### Experimental Evaluation

### Functionality

DAWSON is preferably implemented on Windows® XP platforms, including SP1 and SP2; however other versions are typically acceptable. The XP SP1 system has the default configuration with one typical change: the addition of Microsoft SQL Server version 8.00.194.

Over several test months, this system was used for routine applications while developing and improving the DAWSON system. In this process, several applications are routinely excised including: Internet Explorer, SQLServer, Windbg, Windows® Explorer, Word, WordPad, Notepad, Regedit, and so on. The use of Windbg was used to print the memory map of these applications and verified that all regions have been rebased to random addresses. The addition of randomization has been without a glitch, and did not caused any perceptible loss of functionality or performance.

### Effectiveness in Stopping Real-world Attacks

DAWSON's effectiveness in stopping several real-world attacks was also tested, using the Metasploit framework (http://www.metasploit.com/) for testing purposes. The testing included all working metasploit attacks that were applicable to the test platform (Windows® XP SP1), and are shown in Table 2. First, DAWSON protection was disabled and verified that the exploits were successful. Then DAWSON was enabled and the exploits were ran again, and verified that four of the five failed. The successful attack was one that relied on predictability of code addresses in the executable, since DAWSON could not randomize these addresses due to unavailability of relocation information for the executable section for this server. Had the EXE section been randomized, this fifth attack would have failed as well. Specifically, it used a stack-smashing vulnerability to return to a specific location in the executable. This location had two pop instructions followed by a ret instruction. At the point of return, the stack top contained the value of a pointer that pointed into a buffer on the stack that held the input from the attacker. This meant that the return instruction transferred control to the attacker's code that was stored in this buffer.

TABLE 2
Effectiveness in stopping real-world attacks.

| CVE Id | Target | Attack Type | Effective? |
|---|---|---|---|
| CVE-2003-0533 | Microsoft LSASS | Stack smash/code injection | Yes |
| CVE-2003-0818 | Microsoft ASN.1 Library | Heap overflow/code injection | Yes |
| CVE-2002-0649 | MSSQL 2000/MSDE | Stack smash/code injection | Yes |
| CVE-2002-1123 | MSSQL 2000/MSDE | Stack smash/code injection | Yes |
| CVE-2003-0352 | Microsoft RPC DCOM | Stack-smash/jump to EXE code | No |

### Effectiveness in Stopping Sophisticated Attacks

Real-world attacks tend to be rather simple. So, in order to test the effectiveness against many different types of vulnerabilities, a synthetic application was developed and was seeded with several vulnerabilities. This application is a simple TCP-based server that accepts requests on many ports. Each port P is associated with a unique vulnerability Vₚ. On receiving a connection on a port P, the server spawns a thread that invokes a function fₚ that contains Vₚ, providing the request data as the argument.

The following 9 vulnerabilities were incorporated into the test server: two “stack buffer overflow” vulnerabilities, two types of “integer overflows,” a “format-string vulnerability” involving sprint f on a stack-allocated buffer, and four types of “heap overflows.” Fourteen distinct attacks were developed that exploit these vulnerabilities, including:
stack buffer overflow attacks that overwrite
   return address to point to
      1. injected code on stack
      existing call ESP code in
         2. the executable
         3.ntdll DLL
         4. kerne132 DLL
         5. one of the application's DLLs
      *6. existing code in a DLL (traditional return-to-libc)
   7. a local function pointer to point to injected code on stack—
heap overflow attacks that overwrite
   8. a local function pointer to point to existing code in a DLL
   9. a function pointer in the PEB (specifically, the RtlCriticalSection field) to point to existing code in a DLL
10. aheap lookaside list overflow that overwrites the return address on the stack to point to existing code in a DLL
11. a process heap critical section list overflow that overwrites a local function pointer to existing code in a DLL—
integer overflow attacks that overwrite
   12. a global function pointer to point to existing code in a DLL
   13. an exception handler pointer stored on the stack so that it points to existing code in a DLL
14. a format string exploit on a sprint f function that prints to a stack-allocated buffer. The exploit uses this vulnerability to overwrite the return address so that it points to existing code in a DLL.
   To streamline the whole process, the metasploit framework was used for exploit development. Verification was performed so that when DAWSON is disabled, all these exploits worked on Windows® XP SP1 as well as SP2. Finally, with DAWSON enabled, verification was performed that none of the attacks succeeded.

### Runtime Performance

Performance overheads can be divided into three general categories:
Boot-time overhead: At boot-time, system DLLs are replaced by their rebased versions. The increase in boot time was 1.2 seconds. This measurement was averaged across five test runs.
Process start-up overhead: When processes are started up for the first time, their DLLs are rebased. In addition, an extra DLL (namely, the randomization DLL) is loaded. The increase in process start-up times were measured across the following services: smss.exe, lsass.exe, services.exe, csrss.exe, RPC service, DHCP service, network connection service, DNS client service, server service, and winlogon. The average increase in start-up time across these applications was 8 ms.
Runtime overhead: Almost all randomizations have negligible runtime overheads. Observe that although rebasing changes the base address of various memory regions, it does not change the relative order (i.e., the proximity relations) between data or code objects. In particular, for code and static data, if two objects were in the same memory page before randomization, they will continue to be in the same page after randomization. Similarly, if two objects belonged to the same cache block before randomization, they will continue to be so after randomization. This observation does not hold for the stack due to finer granularity randomization, but this does not seem to have measurable effect at runtime, presumably due to the fact that stack already exhibits a high degree of locality.
The only measurable runtime overhead was due to malloc, since additional processing time was added to each malloc and free. A micro benchmark was used to measure this overhead. This benchmark allocated a 100,000 heap blocks of random sizes up to 64 K. The CPU time spent for a million allocations and frees was 2.22 s, which increased to 2.43 s with DAWSON, an overhead of 9%. Note that this represents the worst-case performance, because applications typically spend most of the CPU time outside of heap management routine where DAWSON doesn't add any runtime overheads. For this reason, any statistically significant runtime overheads could not be measured on any macro benchmark.

DAWSON is a lightweight approach for effective defense of Windows-based systems. All services and applications running on the system are protected by DAWSON. The defense relies on automated randomization of the address space: specifically, all code sections and writable data segments are rebased, providing a minimum of 15-bits of randomness in their location. The effectiveness of DAWSON was established using a combination of theoretical analysis and experiments. DAWSON introduces very low performance overheads, and does not impact the functionality or usability of protected systems. DAWSON does not require access to the source code of applications or the operating system. These factors make DAWSON a viable and practical defense against memory error exploits. A widespread application of this approach will provide an effective defense against the common mode failure problem for the Wintel monoculture.

Various modifications and variations of the described methods and systems of the invention will be apparent to those skilled in the art without departing from the scope and spirit of the invention. Although the invention has been described in connection with specific preferred embodiments, it should be understood that the invention as claimed should not be unduly limited to such specific embodiments. U.S. Provisional Application No. 60/830,122 is incorporated by reference herein in its entirety. Indeed, various modifications of the described modes for carrying out the invention which are obvious to those skilled in the art are intended to be within the scope of any following claims.

We claim:

1. A computer-implemented method of providing address-space randomization for a Windows® operating system in a computer system, the method comprising the steps of:
rebasing system dynamic link libraries (DLLs);
rebasing a Process Environment Block (PEB) and a Thread Environment Block (TEB); and
randomizing a user mode process by hooking functions that set-up internal memory structures for the user mode process,
wherein randomized internal memory structures, the rebased system DLLs, rebased PEB and rebased TEB are each located at different addresses after said respective rebasing step providing a defense against a memory corruption attack and enhancing security of the user mode process in the computer system by generating an alert or defensive action upon an invalid access to a pre-rebased address.

2. A computer-implemented method of providing address-space randomization for a Windows® operating system in a computer system, comprising the steps of:
rebasing a system dynamic link library (DLL) from an initial DLL address to another address, in kernel mode;
rebasing a Process Environment Block (PEB) and Thread Environment Block (TEB) from an initial PEB and initial TEB address to different PEB address and different TEB address, in kernel mode;
rebasing a primary heap from an initial primary heap address to a different primary heap address, from kernel mode,
wherein access to any one of: the initial DLL address, the initial PEB address, the initial TEB address, and initial primary heap address causes an alert or defensive action in the computer system.

3. The computer-implemented method of claim 2, further comprising the step of injecting a user mode DLL at a process start time.

4. The computer-implemented method of claim 2, wherein at least one of the rebasing steps includes hooking functions that perform DLL mapping.

5. The computer-implemented method of claim 2, wherein at least one of the steps for rebasing includes hooking functions that performs thread creation.

6. The computer-implemented method of claim 2, wherein at least one of the steps for rebasing includes hooking functions that performs heap creation.

7. The computer-implemented method of claim 2, wherein at least one of the steps for rebasing includes hooking functions that creates and manipulates heap blocks.

8. The computer-implemented method of claim 2, wherein at least one of the steps for rebasing includes hooking functions that creates a child process.

9. The computer-implemented method of claim 2, wherein at least one step for rebasing includes hooking functions and the hooking provides a wrapper around the real function, the wrapper changing parameters to cause randomizing of a user mode process.

10. The computer-implemented method of claim 9, wherein the step of hooking checks application specific-settings to determine which functions to hook.

11. The computer-implemented method of claim 2, wherein at least one step for rebasing includes at least any one of:
randomizing a DLL Base when a DLL is loaded resulting in a rebased DLL,
randomizing a thread stack when a new thread is created resulting in a rebased thread stack,
randomizing a heap base when a heap is created resulting in a rebased heap,
adding a guard around a heap block when the heap block is allocated, and
randomizing a primary stack by invoking a customized loader to create a process.

12. The computer-implemented method of claim 11, wherein the rebased DLL, the rebased thread stack, and the rebased heap base are each located at different address after the respective randomizing step providing a defense against memory corruption attacks and enhancing security of a user mode process in the computer system.

13. The computer-implemented method of claim 2, further comprising the steps of:
failing and crashing a process associated with a first instance of the memory corruption attack;
learning from the attack and generating a signature to block a further similar attack.

14. The computer-implemented method of claim 13, further comprising the step of building an input function interceptor and maintaining recent input history in memory to facilitate the learning and for generating a vulnerability based signature to block a further similar attack.

15. The computer-implemented method according to claim 2, wherein at least one step for rebasing is configured to check an application setting to determine whether to perform the at least one step for rebasing and by-passing at least a portion of the at least one step for rebasing based on the application setting.

16. The computer-implemented method of claim 15, wherein the at least one step for rebasing includes randomizing a thread stack when a thread is created based on the application setting.

17. The computer-implemented method of claim 15, wherein the at least one step for rebasing includes randomizing a heap base based on the application setting.

18. The computer-implemented method of claim 15, wherein the at least one step for rebasing includes adding a guard around a heap block during allocation of the heap block, based on the application setting.

19. The computer-implemented method of claim 2, wherein the step for rebasing primary heaps from kernel mode includes hooking a system call for ZwAllocateVirtualMemory.

20. The computer-implemented method of claim 19, further comprising the steps of:
for a created process whose application setting has primary heap base randomization turned on, and when CreateProcess callback is invoked for the newly created process,
randomizing a memory location associated with ZwAllocateVirtualMemory for the MEM_RESERVED type of allocations; and
stopping randomization when Load Image callback is invoked for the created process.

21. The computer-implemented method of claim 20, wherein the CreateProcess has a family function wrapper, further comprising the step of invoking a customized loader by calling the customized loader program, the customized loader program configured to perform execution of the steps of:
parse a command line to get a real program name and original command line;
examining the original program executable relocation section and statically linked dependent DLLs;
optionally rebasing the executable relocation section if the relocation section is available and optionally rebasing the statically linked dependents DLLs for maximum randomization;
calling ZwCreateProcess in NTDLL to create a process object;
calling ZwAllocateVirtualMemory to allocate memory for a stack in a randomized location;
call ZwCreateThread to associate the thread with the stack and attach it with the process object; and
setting the created process object to start running by calling ZwResumeThread.

22. A computer-implemented method to perform runtime stack inspection for stack buffer overflow early detection during a computer system attack, the method comprising the steps of:
hooking a memory sensitive function at DLL load time based on an application setting, the memory sensitive function including a function related to any one of:
a memcpy function family, a strcpy function family, and a printf function family;
detecting a violation of a memory space during execution of the hooked memory sensitive function; and
reacting to the violation by generating an alert or preventing further action
by a process associated with the hooked function in the computer system.

23. The computer-implemented system of claim 22, wherein at least one of the steps for hooking, detecting and reacting occur in a Windows® operating system.

24. A computer-implemented method to perform Exception Handler (EH) based access validation and for detecting a computer attack, the method comprising steps:
providing a Exception Handler to a EH list in a computer system employing a Windows® operating system and keeping the provided Exception Handler (EH) as the first EH in the list;
making a copy of a protected resource;
changing a pointer to the protected resource to a erroneous or normally invalid value so that access of the protected resource generates an access violation;
upon the access violation, validating if an accessing instruction is from a legitimate resource having an appropriate permission;
if the step of validating fails to identify a legitimate resource as a source of the access violation, raising an attack alert.

25. The computer-implemented method of claim 24, wherein if the step of validating identifies a legitimate resource, further comprising the step of restoring execution context and continuing execution with a known valid value.

26. The computer-implemented method of claim 25, wherein the step of restoring the execution context includes:
inspecting one or more common purpose registers;
identifying one of the one or more registers having a value close to a known bad value identified by the EH; and
replacing the contents of the identified register with a known valid value.

27. The computer-implemented method of claim 24, wherein if the step for validating fails to identify a legitimate resource as the source of the access violation, starting a vulnerability analysis.

28. The computer-implemented method of claim 24, wherein the method to perform Exception Handler (EH) based access validation detects attacks by protecting any one of the following protected resources:
a PEB/TEB data member;
a Process parameter and Environment variable blocks;
an Export Address Table (EAT);
a Structured Exception Handler (SEH) frame; and
an Unhandled Exception Filter (UEF).

29. A computer implemented method to inject a user mode DLL into a newly created process at initialization time of the process in a computer system employing a Windows® operating system to prevent computer attacks, the method comprising steps of:
finding or creating a kernel memory address that is shared in user mode by mapping the kernel memory address to a virtual address in a user mode address space of a process;
copying instructions in binary form that calls user mode Load Library to the found or created kernel mode address from kernel driver creating shared Load Library instructions; and
queuing an user mode APC call to execute the shared Load Library instructions from user address space of a desired process when it is mapping kernel32 DLL.

30. A system for providing address-space randomization for a Windows® operating system in a computer system, comprising:
means for rebasing a system dynamic link library (DLL) from an initial DLL address to another address, at kernel mode;
means for rebasing a Process Environment Block (PEB) and Thread Environment Block (TEB) from an initial PEB and initial TEB address to different PEB address and different TEB address, at kernel mode; and
means for rebasing a primary heap from an initial primary heap address to a different primary heap address, from kernel mode,
wherein access to any one of: the initial DLL address, the initial PEB address, the initial TEB address, and initial primary heap address causes an alert or defensive action in the computer system.

31. The system for providing address-space randomization of claim 30, further comprising means for injecting a user mode DLL at a process start time.

32. The system for providing address-space randomization of claim 30, wherein at least one of the rebasing steps includes means for hooking functions that perform DLL mapping.

33. The system for providing address-space randomization of claim 30, wherein at least one of the means for rebasing includes means for hooking functions that performs thread creation.

34. The system for providing address-space randomization of claim 30, wherein at least one of the means for rebasing includes means for hooking functions that performs heap creation.

35. The system for providing address-space randomization of claim 30, wherein at least one of the means for rebasing includes means for hooking functions that creates and manipulates heap blocks.

36. The system for providing address-space randomization of claim 30, wherein at least one of the means for rebasing includes means for hooking functions that creates a child process.

37. The system for providing address-space randomization of claim 30, wherein at least one means for rebasing includes means for hooking functions and the hooking provides a wrapper around the real function, the wrapper changing parameters to cause randomizing of a user mode process.

38. The system for providing address-space randomization of claim 30, wherein the means for hooking checks application specific settings to determine which functions to hook.

39. A computer-implemented method of providing address-space randomization for an operating system in a computer system, comprising at least any one of the steps a) through e):
a) rebasing one or more application dynamic link libraries (DLLs);
b) rebasing thread stack and randomizing its starting frame offset;
c) rebasing one or more heap;
d) rebasing a process parameter environment variable block;
e) rebasing primary stack with customized loader; and
wherein at least any one of: the rebased application DLLs, rebased thread stack and its starting frame offset, rebased heap base, the rebased process parameter environment variable block, the rebased primary stack are each located at different memory address away from a respective first address prior to rebasing, and after said respective rebasing step, an access to any first respective address causes an alert or defensive action in the computer system.

40. The computer-implemented method of claim 39, further comprising the step of adding a protecting guard around heap blocks at user mode.

41. The computer-implemented method of claim 39, wherein the operating system is a Windows® operating system.

42. The computer-implemented method of claim 39, wherein the at least any one of the steps a) through e) for rebasing occurs in user mode.

43. A computer program product having computer code embedded in a computer readable medium, the computer code configured to execute the following at least any one of the steps a) through e):
a) rebasing one or more application dynamic link libraries (DLLs);
b) rebasing thread stack and randomizing its starting frame;
c) rebasing one or more heap;
d) rebasing a process parameter environment variable block;
e) rebasing primary stack with customized loader; and
wherein at least any one of: the rebased application DLLs, rebased thread stack and its starting frame offset, rebased heap base, the rebased process parameter environment variable block, the rebased primary stack are each located at different memory address away from a respective first address prior to rebasing, and after said at least any one of the steps a) through e), an access to any first respective address causes an alert or defensive action in the computer system.

44. The computer program product of claim 43, wherein the program code is configured to execute the additional step of adding a protecting guard around heap blocks at user mode.

45. The computer program product of claim 43, wherein the program code is configured to execute in a Windows® operating system environment.

46. The computer program product of claim 43, wherein the at least any one of the steps a) through e) for rebasing occurs in user mode.
